SEQUENCE LISTING (16 sequences)

SEQ ID NO: 1 - protein, 1500 aa, Artificial Sequence
  Description of Artificial SequenceSynthetic protein (TdCV-s)
MVSKGEELFTGVVPILVELDGDVNGHKFSVSGEGEGDATYGKLTLKFICTTGKLPVPWPTLVTTLTWGVQCFSRYPDHMKQHDFFKSAMPEGYVQERTIFFKDDGNYKTRAEVKFEGDTLVNRIELKGIDFKEDGNILGHKLEYNYISHNVYITADKQKNGIKANFKIRHNIEDGSVQLADHYQQNTPIGDGPVLLPDNHYLSTQSALSKDPNEKRDHMVLLEFVTAARRRPEAAAREAAARSGSRKRSSAREAAARSGSLEMVSKGEELFTGVVPILVELDGDVNGHKFSVSGEGEGDATYGKLTLKLICTTGKLPVPWPTLVTTLGYGLQCFARYPDHMKQHDFFKSAMPEGYVQERTIFFKDDGNYKTRAEVKFEGDTLVNRIELKGIDFKEDGNILGHKLEYNYNSHNVYITADKQKNGIKANFKIRHNIEDGGVQLADHYQQNTPIGDGPVLLPDNHYLSYQSALSKDPNEKRDHMVLLEFVTAAGITLGMDELYKEFMENAHTKTVEEVLGHFGVNESTGLSLEQVKKLKERWGSNELPAEEGKTLLELVIEQFEDLLVRILLLAACISFVLAWFEEGEETITAFVEPFVILLILVANAIVGVWQERNAENAIEALKEYEPEMGKVYRQDRKSVQRIKAKDIVPGDIVEIAVGDKVPADIRLTSIKSTTLRVDQSILTGESVSVIKHTDPVPDPRAVNQDKKNMLFSGTNIAAGKAMGVVVATGVNTEIGKIRDEMVATEQERTPLQQKLDEFGEQLSKVISLICIAVWIINIGHFNDPVHGGSWIRGAIYYFKIAVALAVAAIPEGLPAVITTCLALGTRRMAKKNAIVRSLPSVETLGCTSVICSDKTGTLTTNQMSVCRMFILDKVEGDTCSLNEFTITGSTYAPIGEVHKDDKPVKCHQYDGLVELATICALCNDSALDYNEAKGVYEKVGEATETALTCLVEKMNVFDTELKGLSKIERANACNSVIKQLMKKEFTLEFSRDRKSMSVYCTPNKPSRTSMSKMFVKGAPEGVIDRCTHIRVGSTKVPMTPGVKQKIMSVIREWGSGSDTLRCLALATHDNPMRREEMNLEDSANFIKYETNLTFVGCVGMLDPPRIEVASSVKLCRQAGIRVIMITGDNKGTAVAICRRIGIFGQDEDVTSKAFTGREFDELNPSAQREACLNARCFARVEPSHKSKIVEFLQSFDEITAMTGDGVNDAPALKKSEIGIAMGSGTAVAKTASEMVLADDNFSTIVAAVEEGRAIYNNMKQFIRYLISSNVGEVVCIFLTAALGFPEALIPVQLLWVNLVTDGLPATALGFNPPDLDIMNKPPRNPKEPLISGWLFFRYLAIGCYVGAATVGAAAWWFIAADGGPRVTFYQLSHFLQCKEDNPDFEGVDCAVFESPYPMTMALSVLVTIEMCNALNSLSENQSLLRMPPWENIWLVGSICLSMSLHFLILYVEPLPLIFQITPLNLTQWLMVLKISLPVILMDETLKFVARNYLEPAILE

SEQ ID NO: 2 - protein, 1485 aa, Artificial Sequence
  Description of Artificial SequenceSynthetic protein (V-G374)
MVSKGEELFTGVVPILVELDGDVNGHKFSVSGEGEGDATYGKLTLKFICTTGKLPVPWPTLVTTLTWGVQCFSRYPDHMKQHDFFKSAMPEGYVQERTIFFKDDGNYKTRAEVKFEGDTLVNRIELKGIDFKEDGNILGHKLEYNYISHNVYITADKQKNGIKANFKIRHNIEDGSVQLADHYQQNTPIGDGPVLLPDNHYLSTQSALSKDPNEKRDHMVLLEFVTAAGITLGMDELYKGSLMENAHTKTVEEVLGHFGVNESTGLSLEQVKKLKERWGSNELPAEEGKTLLELVIEQFEDLLVRILLLAACISFVLAWFEEGEETITAFVEPFVILLILVANAIVGVWQERNAENAIEALKEYEPEMGKVYRQDRKSVQRIKAKDIVPGDIVEIAVGDKVPADIRLTSIKSTTLRVDQSILTGESVSVIKHTDPVPDPRAVNQDKKNMLFSGTNIAAGKAMGVVVATGVNTEIGKIRDEMVATEQERTPLQQKLDEFGEQLSKVISLICIAVWIINIGHFNDPVHGGSWIRGAIYYFKIAVALAVAAIPEGLPAVITTCLALGTRRMAKKNAIVRSLPSVETLGCTSVICSDKTGTLTTNQMSVCRMFILDKVEGGGSMVSKGEELFTGVVPILVELDGDVNGHKFSVSGEGEGDATYGKLTLKLICTTGKLPVPWPTLVTTLGYGLQCFARYPDHMKQHDFFKSAMPEGYVQERTIFFKDDGNYKTRAEVKFEGDTLVNRIELKGIDFKEDGNILGHKLEYNYNSHNVYITADKQKNGIKANFKIRHNIEDGGVQLADHYQQNTPIGDGPVLLPDNHYLSYQSALSKDPNEKRDHMVLLEFVTAAGITLGMDELYKNSGGDTCSLNEFTITGSTYAPIGEVHKDDKPVKCHQYDGLVELATICALCNDSALDYNEAKGVYEKVGEATETALTCLVEKMNVFDTELKGLSKIERANACNSVIKQLMKKEFTLEFSRDRKSMSVYCTPNKPSRTSMSKMFVKGAPEGVIDRCTHIRVGSTKVPMTPGVKQKIMSVIREWGSGSDTLRCLALATHDNPMRREEMNLEDSANFIKYETNLTFVGCVGMLDPPRIEVASSVKLCRQAGIRVIMITGDNKGTAVAICRRIGIFGQDEDVTSKAFTGREFDELNPSAQREACLNARCFARVEPSHKSKIVEFLQSFDEITAMTGDGVNDAPALKKSEIGIAMGSGTAVAKTASEMVLADDNFSTIVAAVEEGRAIYNNMKQFIRYLISSNVGEVVCIFLTAALGFPEALIPVQLLWVNLVTDGLPATALGFNPPDLDIMNKPPRNPKEPLISGWLFFRYLAIGCYVGAATVGAAAWWFIAADGGPRVTFYQLSHFLQCKEDNPDFEGVDCAVFESPYPMTMALSVLVTIEMCNALNSLSENQSLLRMPPWENIWLVGSICLSMSLHFLILYVEPLPLIFQITPLNLTQWLMVLKISLPVILMDETLKFVARNYLEPAILE

SEQ ID NO: 3 - protein, 1485 aa, Artificial Sequence
  Description of Artificial SequenceSynthetic protein (V-L577)
MVSKGEELFTGVVPILVELDGDVNGHKFSVSGEGEGDATYGKLTLKFICTTGKLPVPWPTLVTTLTWGVQCFSRYPDHMKQHDFFKSAMPEGYVQERTIFFKDDGNYKTRAEVKFEGDTLVNRIELKGIDFKEDGNILGHKLEYNYISHNVYITADKQKNGIKANFKIRHNIEDGSVQLADHYQQNTPIGDGPVLLPDNHYLSTQSALSKDPNEKRDHMVLLEFVTAAGITLGMDELYKGSLMENAHTKTVEEVLGHFGVNESTGLSLEQVKKLKERWGSNELPAEEGKTLLELVIEQFEDLLVRILLLAACISFVLAWFEEGEETITAFVEPFVILLILVANAIVGVWQERNAENAIEALKEYEPEMGKVYRQDRKSVQRIKAKDIVPGDIVEIAVGDKVPADIRLTSIKSTTLRVDQSILTGESVSVIKHTDPVPDPRAVNQDKKNMLFSGTNIAAGKAMGVVVATGVNTEIGKIRDEMVATEQERTPLQQKLDEFGEQLSKVISLICIAVWIINIGHFNDPVHGGSWIRGAIYYFKIAVALAVAAIPEGLPAVITTCLALGTRRMAKKNAIVRSLPSVETLGCTSVICSDKTGTLTTNQMSVCRMFILDKVEGDTCSLNEFTITGSTYAPIGEVHKDDKPVKCHQYDGLVELATICALCNDSALDYNEAKGVYEKVGEATETALTCLVEKMNVFDTELKGLSKIERANACNSVIKQLMKKEFTLEFSRDRKSMSVYCTPNKPSRTSMSKMFVKGAPEGVIDRCTHIRVGSTKVPMTPGVKQKIMSVIREWGSGSDTLRCLALATHDNPMRREEMNLGGSMVSKGEELFTGVVPILVELDGDVNGHKFSVSGEGEGDATYGKLTLKLICTTGKLPVPWPTLVTTLGYGLQCFARYPDHMKQHDFFKSAMPEGYVQERTIFFKDDGNYKTRAEVKFEGDTLVNRIELKGIDFKEDGNILGHKLEYNYNSHNVYITADKQKNGIKANFKIRHNIEDGGVQLADHYQQNTPIGDGPVLLPDNHYLSYQSALSKDPNEKRDHMVLLEFVTAAGITLGMDELYKNSGGEDSANFIKYETNLTFVGCVGMLDPPRIEVASSVKLCRQAGIRVIMITGDNKGTAVAICRRIGIFGQDEDVTSKAFTGREFDELNPSAQREACLNARCFARVEPSHKSKIVEFLQSFDEITAMTGDGVNDAPALKKSEIGIAMGSGTAVAKTASEMVLADDNFSTIVAAVEEGRAIYNNMKQFIRYLISSNVGEVVCIFLTAALGFPEALIPVQLLWVNLVTDGLPATALGFNPPDLDIMNKPPRNPKEPLISGWLFFRYLAIGCYVGAATVGAAAWWFIAADGGPRVTFYQLSHFLQCKEDNPDFEGVDCAVFESPYPMTMALSVLVTIEMCNALNSLSENQSLLRMPPWENIWLVGSICLSMSLHFLILYVEPLPLIFQITPLNLTQWLMVLKISLPVILMDETLKFVARNYLEPAILE

SEQ ID NO: 4 - protein, 1252 aa, Artificial Sequence
  Description of Artificial SequenceSynthetic protein (F-L577)
MVSKGEELFTGVVPILVELDGDVNGHKFSVSGEGEGDATYGKLTLKFICTTGKLPVPWPTLVTTLTWGVQCFSRYPDHMKQHDFFKSAMPEGYVQERTIFFKDDGNYKTRAEVKFEGDTLVNRIELKGIDFKEDGNILGHKLEYNYISHNVYITADKQKNGIKANFKIRHNIEDGSVQLADHYQQNTPIGDGPVLLPDNHYLSTQSALSKDPNEKRDHMVLLEFVTAAGITLGMDELYKGSLMENAHTKTVEEVLGHFGVNESTGLSLEQVKKLKERWGSNELPAEEGKTLLELVIEQFEDLLVRILLLAACISFVLAWFEEGEETITAFVEPFVILLILVANAIVGVWQERNAENAIEALKEYEPEMGKVYRQDRKSVQRIKAKDIVPGDIVEIAVGDKVPADIRLTSIKSTTLRVDQSILTGESVSVIKHTDPVPDPRAVNQDKKNMLFSGTNIAAGKAMGVVVATGVNTEIGKIRDEMVATEQERTPLQQKLDEFGEQLSKVISLICIAVWIINIGHFNDPVHGGSWIRGAIYYFKIAVALAVAAIPEGLPAVITTCLALGTRRMAKKNAIVRSLPSVETLGCTSVICSDKTGTLTTNQMSVCRMFILDKVEGDTCSLNEFTITGSTYAPIGEVHKDDKPVKCHQYDGLVELATICALCNDSALDYNEAKGVYEKVGEATETALTCLVEKMNVFDTELKGLSKIERANACNSVIKQLMKKEFTLEFSRDRKSMSVYCTPNKPSRTSMSKMFVKGAPEGVIDRCTHIRVGSTKVPMTPGVKQKIMSVIREWGSGSDTLRCLALATHDNPMRREEMNLGGSCCPGCCNSGGEDSANFIKYETNLTFVGCVGMLDPPRIEVASSVKLCRQAGIRVIMITGDNKGTAVAICRRIGIFGQDEDVTSKAFTGREFDELNPSAQREACLNARCFARVEPSHKSKIVEFLQSFDEITAMTGDGVNDAPALKKSEIGIAMGSGTAVAKTASEMVLADDNFSTIVAAVEEGRAIYNNMKQFIRYLISSNVGEVVCIFLTAALGFPEALIPVQLLWVNLVTDGLPATALGFNPPDLDIMNKPPRNPKEPLISGWLFFRYLAIGCYVGAATVGAAAWWFIAADGGPRVTFYQLSHFLQCKEDNPDFEGVDCAVFESPYPMTMALSVLVTIEMCNALNSLSENQSLLRMPPWENIWLVGSICLSMSLHFLILYVEPLPLIFQITPLNLTQWLMVLKISLPVILMDETLKFVARNYLEPAILE

SEQ ID NO: 5 - protein, 1485 aa, Artificial Sequence
  Description of Artificial SequenceSynthetic protein (V-G519)
MVSKGEELFTGVVPILVELDGDVNGHKFSVSGEGEGDATYGKLTLKFICTTGKLPVPWPTLVTTLTWGVQCFSRYPDHMKQHDFFKSAMPEGYVQERTIFFKDDGNYKTRAEVKFEGDTLVNRIELKGIDFKEDGNILGHKLEYNYISHNVYITADKQKNGIKANFKIRHNIEDGSVQLADHYQQNTPIGDGPVLLPDNHYLSTQSALSKDPNEKRDHMVLLEFVTAAGITLGMDELYKGSLMENAHTKTVEEVLGHFGVNESTGLSLEQVKKLKERWGSNELPAEEGKTLLELVIEQFEDLLVRILLLAACISFVLAWFEEGEETITAFVEPFVILLILVANAIVGVWQERNAENAIEALKEYEPEMGKVYRQDRKSVQRIKAKDIVPGDIVEIAVGDKVPADIRLTSIKSTTLRVDQSILTGESVSVIKHTDPVPDPRAVNQDKKNMLFSGTNIAAGKAMGVVVATGVNTEIGKIRDEMVATEQERTPLQQKLDEFGEQLSKVISLICIAVWIINIGHFNDPVHGGSWIRGAIYYFKIAVALAVAAIPEGLPAVITTCLALGTRRMAKKNAIVRSLPSVETLGCTSVICSDKTGTLTTNQMSVCRMFILDKVEGDTCSLNEFTITGSTYAPIGEVHKDDKPVKCHQYDGLVELATICALCNDSALDYNEAKGVYEKVGEATETALTCLVEKMNVFDTELKGLSKIERANACNSVIKQLMKKEFTLEFSRDRKSMSVYCTPNKPSRTSMSKMFVKGAPEGGGSMVSKGEELFTGVVPILVELDGDVNGHKFSVSGEGEGDATYGKLTLKLICTTGKLPVPWPTLVTTLGYGLQCFARYPDHMKQHDFFKSAMPEGYVQERTIFFKDDGNYKTRAEVKFEGDTLVNRIELKGIDFKEDGNILGHKLEYNYNSHNVYITADKQKNGIKANFKIRHNIEDGGVQLADHYQQNTPIGDGPVLLPDNHYLSYQSALSKDPNEKRDHMVLLEFVTAAGITLGMDELYKNSGGVIDRCTHIRVGSTKVPMTPGVKQKIMSVIREWGSGSDTLRCLALATHDNPMRREEMNLEDSANFIKYETNLTFVGCVGMLDPPRIEVASSVKLCRQAGIRVIMITGDNKGTAVAICRRIGIFGQDEDVTSKAFTGREFDELNPSAQREACLNARCFARVEPSHKSKIVEFLQSFDEITAMTGDGVNDAPALKKSEIGIAMGSGTAVAKTASEMVLADDNFSTIVAAVEEGRAIYNNMKQFIRYLISSNVGEVVCIFLTAALGFPEALIPVQLLWVNLVTDGLPATALGFNPPDLDIMNKPPRNPKEPLISGWLFFRYLAIGCYVGAATVGAAAWWFIAADGGPRVTFYQLSHFLQCKEDNPDFEGVDCAVFESPYPMTMALSVLVTIEMCNALNSLSENQSLLRMPPWENIWLVGSICLSMSLHFLILYVEPLPLIFQITPLNLTQWLMVLKISLPVILMDETLKFVARNYLEPAILE

SEQ ID NO: 6 - DNA, 4503 bp, Artificial Sequence
  Description of Artificial SequenceSynthetic nucleotide (TdCV-s)
atggtgagcaagggcgaggagctgttcaccggggtggtgcccatcctggtcgagctggacggcgacgtaaacggccacaagttcagcgtgtccggcgagggcgagggcgatgccacctacggcaagctgaccctgaagttcatctgcaccaccggcaagctgcccgtgccctggcccaccctcgtgaccaccctgacctggggcgtgcagtgcttcagccgctaccccgaccacatgaagcagcacgacttcttcaagtccgccatgcccgaaggctacgtccaggagcgcaccatcttcttcaaggacgacggcaactacaagacccgcgccgaggtgaagttcgagggcgacaccctggtgaaccgcatcgagctgaagggcatcgacttcaaggaggacggcaacatcctggggcacaagctggagtacaactacatcagccacaacgtctatatcaccgccgacaagcagaagaacggcatcaaggccaacttcaagatccgccacaacatcgaggacggcagcgtgcagctcgccgaccactaccagcagaacacccccatcggcgacggccccgtgctgctgcccgacaaccactacctgagcacccagtccgccctgagcaaagaccccaacgagaagcgcgatcacatggtcctgctggagttcgtgaccgccgcccgccggcggcccgaagctgctgctcgtgaagctgctgctcgtagcggtagtcgaaagcgaagctctgctcgtgaagctgctgctcgtagtggtagtctcgagatggtgagcaagggcgaggagctgttcaccggggtggtgcccatcctggtcgagctggacggcgacgtaaacggccacaagttcagcgtgtccggcgagggcgagggcgatgccacctacggcaagctgaccctgaagctgatctgcaccaccggcaagctgcccgtgccctggcccaccctcgtgaccaccctgggctacggcctgcagtgcttcgcccgctaccccgaccacatgaagcagcacgacttcttcaagtccgccatgcccgaaggctacgtccaggagcgcaccatcttcttcaaggacgacggcaactacaagacccgcgccgaggtgaagttcgagggcgacaccctggtgaaccgcatcgagctgaagggcatcgacttcaaggaggacggcaacatcctggggcacaagctggagtacaactacaacagccacaacgtctatatcaccgccgacaagcagaagaacggcatcaaggccaacttcaagatccgccacaacatcgaggacggcggcgtgcagctcgccgaccactaccagcagaacacccccatcggcgacggccccgtgctgctgcccgacaaccactacctgagctaccagtccgccctgagcaaagaccccaacgagaagcgcgatcacatggtcctgctggagttcgtgaccgccgccgggatcactctcggcatggacgagctgtacaaggaattcatggagaacgcgcacacaaagacggtggaggaggtgctgggccacttcggcgtcaacgagagcacggggctgagcctggagcaggtcaagaagctcaaggagagatggggctccaacgagttaccggctgaagaagggaaaaccttgctggaacttgtgattgagcagtttgaagacttactcgttagaattttattgttggcagcatgtatatcttttgttttggcttggtttgaagaaggcgaagaaacaattacagcctttgtagaaccctttgtaattttacttatattagtagccaatgcaattgtgggtgtatggcaggaaaggaatgcagaaaatgccatcgaagcccttaaggagtatgagcctgaaatgggcaaagtgtatcgacaggacaggaagagtgtacaacgaattaaagctaaagacatagttcctggtgatattgtagaaattgctgttggtgacaaagttcctgctgatataagattaacgtccatcaaatctactactctaagagttgaccagtcaattctcacaggtgagtctgtctctgtcatcaagcacaccgaccctgtccctgacccacgggctgtcaaccaagataagaagaacatgctcttttctggtacaaacatagcagctggcaaagccatgggagtggtggtggcaactggagttaacactgaaattggcaagatccgggatgaaatggtagcaacggaacaggagagaacacccctccagcagaaactagatgagtttggggaacagctttccaaagtcatctcccttatttgcattgcagtctggatcataaacattgggcacttcaatgacccggttcatggaggctcctggatcagaggtgctatttattactttaaaattgcagtggccctggctgtagcagccattcctgaaggcctgcctgctgtcattaccacctgcctggctcttggaactcgtagaatggcaaagaaaaatgccattgttcgaagtctcccttctgtggaaacccttggttgcacttccgttatctgctcagacaagactggtacacttacaacaaaccagatgtcagtctgcaggatgttcattctggacaaagttgaaggtgatacttgttccctgaatgagtttaccataactggatcaacatatgctcctattggagaagtccataaagatgataaaccagtaaagtgtcatcaatatgatggtcttgtggaattggcaacaatttgtgctctctgtaatgactctgctttggattacaatgaggcaaagggtgtgtatgaaaaagttggagaagctacagagactgctctcacttgcctggtagagaagatgaatgtctttgatactgagttaaagggtctttctaaaatagaacgagcaaatgcctgcaactcggtcattaaacaattgatgaaaaaggaatttactctagagttttcacgtgatagaaaatcaatgtcagtttattgtacaccaaacaaaccaagccggacatcgatgagcaaaatgtttgtgaagggtgctcccgaaggtgtcattgacaggtgtacccacattcgagttggaagtactaaagtccccatgactcctggcgtcaaacagaagatcatgtctgtcattcgggaatggggcagtggcagcgacacactgcgatgcctggctctggccactcatgacaacccgatgagaagagaagaaatgaaccttgaggattctgccaactttattaaatacgagaccaatctgactttcgttggctgtgtgggcatgctggaccctccaagaatcgaagtggcctcctctgtgaagctgtgccggcaggcaggcatccgggtcattatgatcacaggcgacaacaagggtaccgctgtggccatctgccgtcgcattggcatctttgggcaggacgaggatgtgacgtcaaaggcttttacaggtcgggagtttgatgagctcaatccttcagcccagagagaagcctgcctgaatgcccgctgtttcgctcgagttgaaccttcccacaagtctaaaattgtagaatttcttcagtcttttgatgagattacagctatgactggggacggtgtgaatgatgctcctgctctgaagaagtctgagatcggcattgccatgggctctggcaccgcggtggctaaaactgcctccgagatggtcctggctgatgacaacttctccaccattgtggctgctgtggaggagggacgggcaatatacaacaacatgaagcagttcattcgctacctcatctcgtccaacgtgggagaagttgtctgtattttcctgacagcagcccttggatttcctgaggctttaattcctgtccagctgctctgggtcaatctggtgacagatggcctgcctgccactgcactggggttcaatcctcctgatctggacattatgaacaaaccaccccggaacccaaaggaaccactgatcagtgggtggctctttttccgctacctggctattggctgttacgttggtgctgctactgtgggtgctgctgcgtggtggttcattgctgccgatggtggtccgagagtgaccttctaccagctgagtcatttcctacagtgtaaagaggacaacccagactttgagggagtggattgtgcagtctttgaatccccttacccaatgacaatggcgctgtctgttctagtcaccatagagatgtgtaacgccctcaacagtttgtcggaaaaccagtccctgctaaggatgccaccttgggagaacatttggctcgtgggctccatctgcctgtccatgtcactccacttcctaatcctctatgtggaacccctgccacttatcttccagatcacaccgctgaatttgacccagtggctgatggtgctgaaaatctccttgcctgtgattctaatggatgagaccctcaagtttgtggcccgcaactacctggaacctgcaatactggagtaa

SEQ ID NO: 7 - DNA, 4458 bp, Artificial Sequence
  Description of Artificial SequenceSynthetic nucleotide (V-G374)
atggtgagcaagggcgaggagctgttcaccggggtggtgcccatcctggtcgagctggacggcgacgtaaacggccacaagttcagcgtgtccggcgagggcgagggcgatgccacctacggcaagctgaccctgaagttcatctgcaccaccggcaagctgcccgtgccctggcccaccctcgtgaccaccctgacctggggcgtgcagtgcttcagccgctaccccgaccacatgaagcagcacgacttcttcaagtccgccatgcccgaaggctacgtccaggagcgcaccatcttcttcaaggacgacggcaactacaagacccgcgccgaggtgaagttcgagggcgacaccctggtgaaccgcatcgagctgaagggcatcgacttcaaggaggacggcaacatcctggggcacaagctggagtacaactacatcagccacaacgtctatatcaccgccgacaagcagaagaacggcatcaaggccaacttcaagatccgccacaacatcgaggacggcagcgtgcagctcgccgaccactaccagcagaacacccccatcggcgacggccccgtgctgctgcccgacaaccactacctgagcacccagtccgccctgagcaaagaccccaacgagaagcgcgatcacatggtcctgctggagttcgtgaccgccgccgggatcactctcggcatggacgagctgtacaagggatccctcatggagaacgcgcacacaaagacggtggaggaggtgctgggccacttcggcgtcaacgagagcacggggctgagcctggagcaggtcaagaagctcaaggagagatggggctccaacgagttaccggctgaagaagggaaaaccttgctggaacttgtgattgagcagtttgaagacttactcgttagaattttattgttggcagcatgtatatcttttgttttggcttggtttgaagaaggcgaagaaacaattacagcctttgtagaaccctttgtaattttacttatattagtagccaatgcaattgtgggtgtatggcaggaaaggaatgcagaaaatgccatcgaagcccttaaggagtatgagcctgaaatgggcaaagtgtatcgacaggacaggaagagtgtacaacgaattaaagctaaagacatagttcctggtgatattgtagaaattgctgttggtgacaaagttcctgctgatataagattaacgtccatcaaatctactactctaagagttgaccagtcaattctcacaggtgagtctgtctctgtcatcaagcacaccgaccctgtccctgacccacgggctgtcaaccaagataagaagaacatgctcttttctggtacaaacatagcagctggcaaagccatgggagtggtggtggcaactggagttaacactgaaattggcaagatccgggatgaaatggtagcaacggaacaggagagaacacccctccagcagaaactagatgagtttggggaacagctttccaaagtcatctcccttatttgcattgcagtctggatcataaacattgggcacttcaatgacccggttcatggaggctcctggatcagaggtgctatttattactttaaaattgcagtggccctggctgtagcagccattcctgaaggcctgcctgctgtcattaccacctgcctggctcttggaactcgtagaatggcaaagaaaaatgccattgttcgaagtctcccttctgtggaaacccttggttgcacttccgttatctgctcagacaagactggtacacttacaacaaaccagatgtcagtctgcaggatgttcattctggacaaagttgaaggtggaggatccatggtgagcaagggcgaggagctgttcaccggggtggtgcccatcctggtcgagctggacggcgacgtaaacggccacaagttcagcgtgtccggcgagggcgagggcgatgccacctacggcaagctgaccctgaagctgatctgcaccaccggcaagctgcccgtgccctggcccaccctcgtgaccaccctgggctacggcctgcagtgcttcgcccgctaccccgaccacatgaagcagcacgacttcttcaagtccgccatgcccgaaggctacgtccaggagcgcaccatcttcttcaaggacgacggcaactacaagacccgcgccgaggtgaagttcgagggcgacaccctggtgaaccgcatcgagctgaagggcatcgacttcaaggaggacggcaacatcctggggcacaagctggagtacaactacaacagccacaacgtctatatcaccgccgacaagcagaagaacggcatcaaggccaacttcaagatccgccacaacatcgaggacggcggcgtgcagctcgccgaccactaccagcagaacacccccatcggcgacggccccgtgctgctgcccgacaaccactacctgagctaccagtccgccctgagcaaagaccccaacgagaagcgcgatcacatggtcctgctggagttcgtgaccgccgccgggatcactctcggcatggacgagctgtacaagaattccggaggtgatacttgttccctgaatgagtttaccataactggatcaacatatgctcctattggagaagtccataaagatgataaaccagtaaagtgtcatcaatatgatggtcttgtggaattggcaacaatttgtgctctctgtaatgactctgctttggattacaatgaggcaaagggtgtgtatgaaaaagttggagaagctacagagactgctctcacttgcctggtagagaagatgaatgtctttgatactgagttaaagggtctttctaaaatagaacgagcaaatgcctgcaactcggtcattaaacaattgatgaaaaaggaatttactctagagttttcacgtgatagaaaatcaatgtcagtttattgtacaccaaacaaaccaagccggacatcgatgagcaaaatgtttgtgaagggtgctcccgaaggtgtcattgacaggtgtacccacattcgagttggaagtactaaagtccccatgactcctggcgtcaaacagaagatcatgtctgtcattcgggaatggggcagtggcagcgacacactgcgatgcctggctctggccactcatgacaacccgatgagaagagaagaaatgaaccttgaggattctgccaactttattaaatacgagaccaatctgactttcgttggctgtgtgggcatgctggaccctccaagaatcgaagtggcctcctctgtgaagctgtgccggcaggcaggcatccgggtcattatgatcacaggcgacaacaagggtaccgctgtggccatctgccgtcgcattggcatctttgggcaggacgaggatgtgacgtcaaaggcttttacaggtcgggagtttgatgagctcaatccttcagcccagagagaagcctgcctgaatgcccgctgtttcgctcgagttgaaccttcccacaagtctaaaattgtagaatttcttcagtcttttgatgagattacagctatgactggggacggtgtgaatgatgctcctgctctgaagaagtctgagatcggcattgccatgggctctggcaccgcggtggctaaaactgcctccgagatggtcctggctgatgacaacttctccaccattgtggctgctgtggaggagggacgggcaatatacaacaacatgaagcagttcattcgctacctcatctcgtccaacgtgggagaagttgtctgtattttcctgacagcagcccttggatttcctgaggctttaattcctgtccagctgctctgggtcaatctggtgacagatggcctgcctgccactgcactggggttcaatcctcctgatctggacattatgaacaaaccaccccggaacccaaaggaaccactgatcagtgggtggctctttttccgctacctggctattggctgttacgttggtgctgctactgtgggtgctgctgcgtggtggttcattgctgccgatggtggtccgagagtgaccttctaccagctgagtcatttcctacagtgtaaagaggacaacccagactttgagggagtggattgtgcagtctttgaatccccttacccaatgacaatggcgctgtctgttctagtcaccatagagatgtgtaacgccctcaacagtttgtcggaaaaccagtccctgctaaggatgccaccttgggagaacatttggctcgtgggctccatctgcctgtccatgtcactccacttcctaatcctctatgtggaacccctgccacttatcttccagatcacaccgctgaatttgacccagtggctgatggtgctgaaaatctccttgcctgtgattctaatggatgagaccctcaagtttgtggcccgcaactacctggaacctgcaatactggagtaa

SEQ ID NO: 8 - DNA, 4458 bp, Artificial Sequence
  Description of Artificial SequenceSynthetic nucleotide (V-L577)
atggtgagcaagggcgaggagctgttcaccggggtggtgcccatcctggtcgagctggacggcgacgtaaacggccacaagttcagcgtgtccggcgagggcgagggcgatgccacctacggcaagctgaccctgaagttcatctgcaccaccggcaagctgcccgtgccctggcccaccctcgtgaccaccctgacctggggcgtgcagtgcttcagccgctaccccgaccacatgaagcagcacgacttcttcaagtccgccatgcccgaaggctacgtccaggagcgcaccatcttcttcaaggacgacggcaactacaagacccgcgccgaggtgaagttcgagggcgacaccctggtgaaccgcatcgagctgaagggcatcgacttcaaggaggacggcaacatcctggggcacaagctggagtacaactacatcagccacaacgtctatatcaccgccgacaagcagaagaacggcatcaaggccaacttcaagatccgccacaacatcgaggacggcagcgtgcagctcgccgaccactaccagcagaacacccccatcggcgacggccccgtgctgctgcccgacaaccactacctgagcacccagtccgccctgagcaaagaccccaacgagaagcgcgatcacatggtcctgctggagttcgtgaccgccgccgggatcactctcggcatggacgagctgtacaagggatccctcatggagaacgcgcacacaaagacggtggaggaggtgctgggccacttcggcgtcaacgagagcacggggctgagcctggagcaggtcaagaagctcaaggagagatggggctccaacgagttaccggctgaagaagggaaaaccttgctggaacttgtgattgagcagtttgaagacttactcgttagaattttattgttggcagcatgtatatcttttgttttggcttggtttgaagaaggcgaagaaacaattacagcctttgtagaaccctttgtaattttacttatattagtagccaatgcaattgtgggtgtatggcaggaaaggaatgcagaaaatgccatcgaagcccttaaggagtatgagcctgaaatgggcaaagtgtatcgacaggacaggaagagtgtacaacgaattaaagctaaagacatagttcctggtgatattgtagaaattgctgttggtgacaaagttcctgctgatataagattaacgtccatcaaatctactactctaagagttgaccagtcaattctcacaggtgagtctgtctctgtcatcaagcacaccgaccctgtccctgacccacgggctgtcaaccaagataagaagaacatgctcttttctggtacaaacatagcagctggcaaagccatgggagtggtggtggcaactggagttaacactgaaattggcaagatccgggatgaaatggtagcaacggaacaggagagaacacccctccagcagaaactagatgagtttggggaacagctttccaaagtcatctcccttatttgcattgcagtctggatcataaacattgggcacttcaatgacccggttcatggaggctcctggatcagaggtgctatttattactttaaaattgcagtggccctggctgtagcagccattcctgaaggcctgcctgctgtcattaccacctgcctggctcttggaactcgtagaatggcaaagaaaaatgccattgttcgaagtctcccttctgtggaaacccttggttgcacttccgttatctgctcagacaagactggtacacttacaacaaaccagatgtcagtctgcaggatgttcattctggacaaagttgaaggtgatacttgttccctgaatgagtttaccataactggatcaacatatgctcctattggagaagtccataaagatgataaaccagtaaagtgtcatcaatatgatggtcttgtggaattggcaacaatttgtgctctctgtaatgactctgctttggattacaatgaggcaaagggtgtgtatgaaaaagttggagaagctacagagactgctctcacttgcctggtagagaagatgaatgtctttgatactgagttaaagggtctttctaaaatagaacgagcaaatgcctgcaactcggtcattaaacaattgatgaaaaaggaatttactctagagttttcacgtgatagaaaatcaatgtcagtttattgtacaccaaacaaaccaagccggacatcgatgagcaaaatgtttgtgaagggtgctcccgaaggtgtcattgacaggtgtacccacattcgagttggaagtactaaagtccccatgactcctggcgtcaaacagaagatcatgtctgtcattcgggaatggggcagtggcagcgacacactgcgatgcctggctctggccactcatgacaacccgatgagaagagaagaaatgaaccttggaggatccatggtgagcaagggcgaggagctgttcaccggggtggtgcccatcctggtcgagctggacggcgacgtaaacggccacaagttcagcgtgtccggcgagggcgagggcgatgccacctacggcaagctgaccctgaagctgatctgcaccaccggcaagctgcccgtgccctggcccaccctcgtgaccaccctgggctacggcctgcagtgcttcgcccgctaccccgaccacatgaagcagcacgacttcttcaagtccgccatgcccgaaggctacgtccaggagcgcaccatcttcttcaaggacgacggcaactacaagacccgcgccgaggtgaagttcgagggcgacaccctggtgaaccgcatcgagctgaagggcatcgacttcaaggaggacggcaacatcctggggcacaagctggagtacaactacaacagccacaacgtctatatcaccgccgacaagcagaagaacggcatcaaggccaacttcaagatccgccacaacatcgaggacggcggcgtgcagctcgccgaccactaccagcagaacacccccatcggcgacggccccgtgctgctgcccgacaaccactacctgagctaccagtccgccctgagcaaagaccccaacgagaagcgcgatcacatggtcctgctggagttcgtgaccgccgccgggatcactctcggcatggacgagctgtacaagaattccggaggtgaggattctgccaactttattaaatacgagaccaatctgactttcgttggctgtgtgggcatgctggaccctccaagaatcgaagtggcctcctctgtgaagctgtgccggcaggcaggcatccgggtcattatgatcacaggcgacaacaagggtaccgctgtggccatctgccgtcgcattggcatctttgggcaggacgaggatgtgacgtcaaaggcttttacaggtcgggagtttgatgagctcaatccttcagcccagagagaagcctgcctgaatgcccgctgtttcgctcgagttgaaccttcccacaagtctaaaattgtagaatttcttcagtcttttgatgagattacagctatgactggggacggtgtgaatgatgctcctgctctgaagaagtctgagatcggcattgccatgggctctggcaccgcggtggctaaaactgcctccgagatggtcctggctgatgacaacttctccaccattgtggctgctgtggaggagggacgggcaatatacaacaacatgaagcagttcattcgctacctcatctcgtccaacgtgggagaagttgtctgtattttcctgacagcagcccttggatttcctgaggctttaattcctgtccagctgctctgggtcaatctggtgacagatggcctgcctgccactgcactggggttcaatcctcctgatctggacattatgaacaaaccaccccggaacccaaaggaaccactgatcagtgggtggctctttttccgctacctggctattggctgttacgttggtgctgctactgtgggtgctgctgcgtggtggttcattgctgccgatggtggtccgagagtgaccttctaccagctgagtcatttcctacagtgtaaagaggacaacccagactttgagggagtggattgtgcagtctttgaatccccttacccaatgacaatggcgctgtctgttctagtcaccatagagatgtgtaacgccctcaacagtttgtcggaaaaccagtccctgctaaggatgccaccttgggagaacatttggctcgtgggctccatctgcctgtccatgtcactccacttcctaatcctctatgtggaacccctgccacttatcttccagatcacaccgctgaatttgacccagtggctgatggtgctgaaaatctccttgcctgtgattctaatggatgagaccctcaagtttgtggcccgcaactacctggaacctgcaatactggagtaa

SEQ ID NO: 9 - DNA, 3759 bp, Artificial Sequence
  Description of Artificial SequenceSynthetic nucleotide (F-L577)
atggtgagcaagggcgaggagctgttcaccggggtggtgcccatcctggtcgagctggacggcgacgtaaacggccacaagttcagcgtgtccggcgagggcgagggcgatgccacctacggcaagctgaccctgaagttcatctgcaccaccggcaagctgcccgtgccctggcccaccctcgtgaccaccctgacctggggcgtgcagtgcttcagccgctaccccgaccacatgaagcagcacgacttcttcaagtccgccatgcccgaaggctacgtccaggagcgcaccatcttcttcaaggacgacggcaactacaagacccgcgccgaggtgaagttcgagggcgacaccctggtgaaccgcatcgagctgaagggcatcgacttcaaggaggacggcaacatcctggggcacaagctggagtacaactacatcagccacaacgtctatatcaccgccgacaagcagaagaacggcatcaaggccaacttcaagatccgccacaacatcgaggacggcagcgtgcagctcgccgaccactaccagcagaacacccccatcggcgacggccccgtgctgctgcccgacaaccactacctgagcacccagtccgccctgagcaaagaccccaacgagaagcgcgatcacatggtcctgctggagttcgtgaccgccgccgggatcactctcggcatggacgagctgtacaagggatccctcatggagaacgcgcacacaaagacggtggaggaggtgctgggccacttcggcgtcaacgagagcacggggctgagcctggagcaggtcaagaagctcaaggagagatggggctccaacgagttaccggctgaagaagggaaaaccttgctggaacttgtgattgagcagtttgaagacttactcgttagaattttattgttggcagcatgtatatcttttgttttggcttggtttgaagaaggcgaagaaacaattacagcctttgtagaaccctttgtaattttacttatattagtagccaatgcaattgtgggtgtatggcaggaaaggaatgcagaaaatgccatcgaagcccttaaggagtatgagcctgaaatgggcaaagtgtatcgacaggacaggaagagtgtacaacgaattaaagctaaagacatagttcctggtgatattgtagaaattgctgttggtgacaaagttcctgctgatataagattaacgtccatcaaatctactactctaagagttgaccagtcaattctcacaggtgagtctgtctctgtcatcaagcacaccgaccctgtccctgacccacgggctgtcaaccaagataagaagaacatgctcttttctggtacaaacatagcagctggcaaagccatgggagtggtggtggcaactggagttaacactgaaattggcaagatccgggatgaaatggtagcaacggaacaggagagaacacccctccagcagaaactagatgagtttggggaacagctttccaaagtcatctcccttatttgcattgcagtctggatcataaacattgggcacttcaatgacccggttcatggaggctcctggatcagaggtgctatttattactttaaaattgcagtggccctggctgtagcagccattcctgaaggcctgcctgctgtcattaccacctgcctggctcttggaactcgtagaatggcaaagaaaaatgccattgttcgaagtctcccttctgtggaaacccttggttgcacttccgttatctgctcagacaagactggtacacttacaacaaaccagatgtcagtctgcaggatgttcattctggacaaagttgaaggtgatacttgttccctgaatgagtttaccataactggatcaacatatgctcctattggagaagtccataaagatgataaaccagtaaagtgtcatcaatatgatggtcttgtggaattggcaacaatttgtgctctctgtaatgactctgctttggattacaatgaggcaaagggtgtgtatgaaaaagttggagaagctacagagactgctctcacttgcctggtagagaagatgaatgtctttgatactgagttaaagggtctttctaaaatagaacgagcaaatgcctgcaactcggtcattaaacaattgatgaaaaaggaatttactctagagttttcacgtgatagaaaatcaatgtcagtttattgtacaccaaacaaaccaagccggacatcgatgagcaaaatgtttgtgaagggtgctcccgaaggtgtcattgacaggtgtacccacattcgagttggaagtactaaagtccccatgactcctggcgtcaaacagaagatcatgtctgtcattcgggaatggggcagtggcagcgacacactgcgatgcctggctctggccactcatgacaacccgatgagaagagaagaaatgaaccttggaggatcctgttgcccaggatgttgcaattccggaggtgaggattctgccaactttattaaatacgagaccaatctgactttcgttggctgtgtgggcatgctggaccctccaagaatcgaagtggcctcctctgtgaagctgtgccggcaggcaggcatccgggtcattatgatcacaggcgacaacaagggtaccgctgtggccatctgccgtcgcattggcatctttgggcaggacgaggatgtgacgtcaaaggcttttacaggtcgggagtttgatgagctcaatccttcagcccagagagaagcctgcctgaatgcccgctgtttcgctcgagttgaaccttcccacaagtctaaaattgtagaatttcttcagtcttttgatgagattacagctatgactggggacggtgtgaatgatgctcctgctctgaagaagtctgagatcggcattgccatgggctctggcaccgcggtggctaaaactgcctccgagatggtcctggctgatgacaacttctccaccattgtggctgctgtggaggagggacgggcaatatacaacaacatgaagcagttcattcgctacctcatctcgtccaacgtgggagaagttgtctgtattttcctgacagcagcccttggatttcctgaggctttaattcctgtccagctgctctgggtcaatctggtgacagatggcctgcctgccactgcactggggttcaatcctcctgatctggacattatgaacaaaccaccccggaacccaaaggaaccactgatcagtgggtggctctttttccgctacctggctattggctgttacgttggtgctgctactgtgggtgctgctgcgtggtggttcattgctgccgatggtggtccgagagtgaccttctaccagctgagtcatttcctacagtgtaaagaggacaacccagactttgagggagtggattgtgcagtctttgaatccccttacccaatgacaatggcgctgtctgttctagtcaccatagagatgtgtaacgccctcaacagtttgtcggaaaaccagtccctgctaaggatgccaccttgggagaacatttggctcgtgggctccatctgcctgtccatgtcactccacttcctaatcctctatgtggaacccctgccacttatcttccagatcacaccgctgaatttgacccagtggctgatggtgctgaaaatctccttgcctgtgattctaatggatgagaccctcaagtttgtggcccgcaactacctggaacctgcaatactggagtaa

SEQ ID NO: 10 - DNA, 4458 bp, Artificial Sequence
  Description of Artificial SequenceSynthetic nucleotide (V-G519)
atggtgagcaagggcgaggagctgttcaccggggtggtgcccatcctggtcgagctggacggcgacgtaaacggccacaagttcagcgtgtccggcgagggcgagggcgatgccacctacggcaagctgaccctgaagttcatctgcaccaccggcaagctgcccgtgccctggcccaccctcgtgaccaccctgacctggggcgtgcagtgcttcagccgctaccccgaccacatgaagcagcacgacttcttcaagtccgccatgcccgaaggctacgtccaggagcgcaccatcttcttcaaggacgacggcaactacaagacccgcgccgaggtgaagttcgagggcgacaccctggtgaaccgcatcgagctgaagggcatcgacttcaaggaggacggcaacatcctggggcacaagctggagtacaactacatcagccacaacgtctatatcaccgccgacaagcagaagaacggcatcaaggccaacttcaagatccgccacaacatcgaggacggcagcgtgcagctcgccgaccactaccagcagaacacccccatcggcgacggccccgtgctgctgcccgacaaccactacctgagcacccagtccgccctgagcaaagaccccaacgagaagcgcgatcacatggtcctgctggagttcgtgaccgccgccgggatcactctcggcatggacgagctgtacaagggatccctcatggagaacgcgcacacaaagacggtggaggaggtgctgggccacttcggcgtcaacgagagcacggggctgagcctggagcaggtcaagaagctcaaggagagatggggctccaacgagttaccggctgaagaagggaaaaccttgctggaacttgtgattgagcagtttgaagacttactcgttagaattttattgttggcagcatgtatatcttttgttttggcttggtttgaagaaggcgaagaaacaattacagcctttgtagaaccctttgtaattttacttatattagtagccaatgcaattgtgggtgtatggcaggaaaggaatgcagaaaatgccatcgaagcccttaaggagtatgagcctgaaatgggcaaagtgtatcgacaggacaggaagagtgtacaacgaattaaagctaaagacatagttcctggtgatattgtagaaattgctgttggtgacaaagttcctgctgatataagattaacgtccatcaaatctactactctaagagttgaccagtcaattctcacaggtgagtctgtctctgtcatcaagcacaccgaccctgtccctgacccacgggctgtcaaccaagataagaagaacatgctcttttctggtacaaacatagcagctggcaaagccatgggagtggtggtggcaactggagttaacactgaaattggcaagatccgggatgaaatggtagcaacggaacaggagagaacacccctccagcagaaactagatgagtttggggaacagctttccaaagtcatctcccttatttgcattgcagtctggatcataaacattgggcacttcaatgacccggttcatggaggctcctggatcagaggtgctatttattactttaaaattgcagtggccctggctgtagcagccattcctgaaggcctgcctgctgtcattaccacctgcctggctcttggaactcgtagaatggcaaagaaaaatgccattgttcgaagtctcccttctgtggaaacccttggttgcacttccgttatctgctcagacaagactggtacacttacaacaaaccagatgtcagtctgcaggatgttcattctggacaaagttgaaggtgatacttgttccctgaatgagtttaccataactggatcaacatatgctcctattggagaagtccataaagatgataaaccagtaaagtgtcatcaatatgatggtcttgtggaattggcaacaatttgtgctctctgtaatgactctgctttggattacaatgaggcaaagggtgtgtatgaaaaagttggagaagctacagagactgctctcacttgcctggtagagaagatgaatgtctttgatactgagttaaagggtctttctaaaatagaacgagcaaatgcctgcaactcggtcattaaacaattgatgaaaaaggaatttactctagagttttcacgtgatagaaaatcaatgtcagtttattgtacaccaaacaaaccaagccggacatcgatgagcaaaatgtttgtgaagggtgctcccgaaggtggaggatccatggtgagcaagggcgaggagctgttcaccggggtggtgcccatcctggtcgagctggacggcgacgtaaacggccacaagttcagcgtgtccggcgagggcgagggcgatgccacctacggcaagctgaccctgaagctgatctgcaccaccggcaagctgcccgtgccctggcccaccctcgtgaccaccctgggctacggcctgcagtgcttcgcccgctaccccgaccacatgaagcagcacgacttcttcaagtccgccatgcccgaaggctacgtccaggagcgcaccatcttcttcaaggacgacggcaactacaagacccgcgccgaggtgaagttcgagggcgacaccctggtgaaccgcatcgagctgaagggcatcgacttcaaggaggacggcaacatcctggggcacaagctggagtacaactacaacagccacaacgtctatatcaccgccgacaagcagaagaacggcatcaaggccaacttcaagatccgccacaacatcgaggacggcggcgtgcagctcgccgaccactaccagcagaacacccccatcggcgacggccccgtgctgctgcccgacaaccactacctgagctaccagtccgccctgagcaaagaccccaacgagaagcgcgatcacatggtcctgctggagttcgtgaccgccgccgggatcactctcggcatggacgagctgtacaagaattccggaggtgtcattgacaggtgtacccacattcgagttggaagtactaaagtccccatgactcctggcgtcaaacagaagatcatgtctgtcattcgggaatggggcagtggcagcgacacactgcgatgcctggctctggccactcatgacaacccgatgagaagagaagaaatgaaccttgaggattctgccaactttattaaatacgagaccaatctgactttcgttggctgtgtgggcatgctggaccctccaagaatcgaagtggcctcctctgtgaagctgtgccggcaggcaggcatccgggtcattatgatcacaggcgacaacaagggtaccgctgtggccatctgccgtcgcattggcatctttgggcaggacgaggatgtgacgtcaaaggcttttacaggtcgggagtttgatgagctcaatccttcagcccagagagaagcctgcctgaatgcccgctgtttcgctcgagttgaaccttcccacaagtctaaaattgtagaatttcttcagtcttttgatgagattacagctatgactggggacggtgtgaatgatgctcctgctctgaagaagtctgagatcggcattgccatgggctctggcaccgcggtggctaaaactgcctccgagatggtcctggctgatgacaacttctccaccattgtggctgctgtggaggagggacgggcaatatacaacaacatgaagcagttcattcgctacctcatctcgtccaacgtgggagaagttgtctgtattttcctgacagcagcccttggatttcctgaggctttaattcctgtccagctgctctgggtcaatctggtgacagatggcctgcctgccactgcactggggttcaatcctcctgatctggacattatgaacaaaccaccccggaacccaaaggaaccactgatcagtgggtggctctttttccgctacctggctattggctgttacgttggtgctgctactgtgggtgctgctgcgtggtggttcattgctgccgatggtggtccgagagtgaccttctaccagctgagtcatttcctacagtgtaaagaggacaacccagactttgagggagtggattgtgcagtctttgaatccccttacccaatgacaatggcgctgtctgttctagtcaccatagagatgtgtaacgccctcaacagtttgtcggaaaaccagtccctgctaaggatgccaccttgggagaacatttggctcgtgggctccatctgcctgtccatgtcactccacttcctaatcctctatgtggaacccctgccacttatcttccagatcacaccgctgaatttgacccagtggctgatggtgctgaaaatctccttgcctgtgattctaatggatgagaccctcaagtttgtggcccgcaactacctggaacctgcaatactggagtaa

SEQ ID NO: 11 - protein, 997 aa, Homo sapiens
MENAHTKTVEEVLGHFGVNESTGLSLEQVKKLKERWGSNELPAEEGKTLLELVIEQFEDLLVRILLLAACISFVLAWFEEGEETITAFVEPFVILLILVANAIVGVWQERNAENAIEALKEYEPEMGKVYRQDRKSVQRIKAKDIVPGDIVEIAVGDKVPADIRLTSIKSTTLRVDQSILTGESVSVIKHTDPVPDPRAVNQDKKNMLFSGTNIAAGKAMGVVVATGVNTEIGKIRDEMVATEQERTPLQQKLDEFGEQLSKVISLICIAVWIINIGHFNDPVHGGSWIRGAIYYFKIAVALAVAAIPEGLPAVITTCLALGTRRMAKKNAIVRSLPSVETLGCTSVICSDKTGTLTTNQMSVCRMFILDKVEGDTCSLNEFTITGSTYAPIGEVHKDDKPVKCHQYDGLVELATICALCNDSALDYNEAKGVYEKVGEATETALTCLVEKMNVFDTELKGLSKIERANACNSVIKQLMKKEFTLEFSRDRKSMSVYCTPNKPSRTSMSKMFVKGAPEGVIDRCTHIRVGSTKVPMTPGVKQKIMSVIREWGSGSDTLRCLALATHDNPMRREEMNLEDSANFIKYETNLTFVGCVGMLDPPRIEVASSVKLCRQAGIRVIMITGDNKGTAVAICRRIGIFGQDEDVTSKAFTGREFDELNPSAQREACLNARCFARVEPSHKSKIVEFLQSFDEITAMTGDGVNDAPALKKSEIGIAMGSGTAVAKTASEMVLADDNFSTIVAAVEEGRAIYNNMKQFIRYLISSNVGEVVCIFLTAALGFPEALIPVQLLWVNLVTDGLPATALGFNPPDLDIMNKPPRNPKEPLISGWLFFRYLAIGCYVGAATVGAAAWWFIAADGGPRVTFYQLSHFLQCKEDNPDFEGVDCAVFESPYPMTMALSVLVTIEMCNALNSLSENQSLLRMPPWENIWLVGSICLSMSLHFLILYVEPLPLIFQITPLNLTQWLMVLKISLPVILMDETLKFVARNYLEPAILE

SEQ ID NO: 12 - protein, 994 aa, Homo sapiens
MEAAHSKSTEECLAYFGVSETTGLTPDQVKRHLEKYGHNELPAEEGKSLWELVIEQFEDLLVRILLLAACISFVLAWFEEGEETITAFVEPFVILLILIANAIVGVWQERNAENAIEALKEYEPEMGKVYRADRKSVQRIKARDIVPGDIVEVAVGDKVPADIRILSIKSTTLRVDQSILTGESVSVIKHTEPVPDPRAVNQDKKNMLFSGTNIAAGKALGIVATTGVSTEIGKIRDQMAATEQDKTPLQQKLDEFGEQLSKVISLICVAVWLINIGHFNDPVHGGSWIRGAIYYFKIAVALAVAAIPEGLPAVITTCLALGTRRMAKKNAIVRSLPSVETLGCTSVICSDKTGTLTTNQMSVCKMFIIDKVDGDFCSLNEFSITGSTYAPEGEVLKNDKPIRSGQFDGLVELATICALCNDSSLDFNETKGVYEKVGEATETALTTLVEKMNVFNTEVRNLSKVERANACNSVIRQLMKKEFTLEFSRDRKSMSVYCSPAKSSRAAVGNKMFVKGAPEGVIDRCNYVRVGTTRVPMTGPVKEKILSVIKEWGTGRDTLRCLALATRDTPPKREEMVLDDSSRFMEYETDLTFVGVVGMLDPPREKVMGSIQLCRDAGIRVIMITGDNKGTAIAICRRIGIFGENEEVADRAYTGREFDDLPLAEQREACRRACCFARVEPSHKSKIVEYLQSYDEITAMTGDGVNDAPALKKAEIGIAMGSGTAVAKTASEMVLADDNFSTIVAAVEEGRAIYNNMKQFIRYLISSNVGEVVCIFLTAALGLPEALIPVQLLWVNLVTDGLPATALGFNPPDLDIMDRPPRSPKEPLISGWLFFRYMAIGGYVGAATVGAAAWWFMYAEDGPGVTYHQLTHFMQCTEDHPHFEGLDCEIFEAPEPMTMALSVLVTIEMCNALNSLSENQSLMRMPPWVNIWLLGSICLSMSLHFLILYVDPLPMIFKLKALDLTQWLMVLKISLPVIGLDEILKFIARNYLEG

SEQ ID NO: 13 - protein, 6 aa, Artificial Sequence
  Description of Artificial SequenceSynthetic oligopeptide (TC-tag)
CCPGCC

SEQ ID NO: 14 - DNA, 18 bp, Artificial Sequence
  Description of Artificial SequenceSynthetic oligonucleotide (TC-tag)
tgttgcccaggatgttgc

SEQ ID NO: 15 - DNA, 26 bp, Artificial Sequence
  PCR primer (TC-tag-FW)
gatcctgttgcccaggatgttgcggg

SEQ ID NO: 16 - DNA, 26 bp, Artificial Sequence
  PCR primer (TC-tag-BW)
aattcccgcaacatcctgggcaacag

(19) United States
(12) Patent Application Publication
(10) Pub. No.: US 2013/0323769 A1
(43) Pub. Date: Dec. 5, 2013

(54) ENDOPLASMIC RETICULUM CALCIUM ATPASE KINETICS INDICATOR AND USE THEREOF

(71) Applicants: Katsuhiko Mikoshiba, Wako-shi (JP); Toru Matsu-Ura, Wako-shi (JP); Kanayo Satoh, Wako-shi (JP)

(72) Inventors: Katsuhiko Mikoshiba, Wako-shi (JP); Toru Matsu-Ura, Wako-shi (JP); Kanayo Satoh, Wako-shi (JP)

(73) Assignees: JAPAN SCIENCE AND TECHNOLOGY AGENCY, Kawaguchi-shi, Saitama (JP); RIKEN, Wako-shi, Saitama (JP)

(21) Appl. No.: 13/979,110

(22) PCT Filed: Jan. 13, 2012
(86) PCT No.: PCT/JP2012/050628

§ 371 Date: Aug. 15, 2013

(30) Foreign Application Priority Data
Jan. 14, 2011 (JP) 2011005797

(51) Int. Cl. G01N 21/64

(52) U.S. Cl. CPC G01N 21/6486
USPC 435/18; 435/188; 536/23.2; 435/320.1; 435/365

(57) ABSTRACT

The present invention provides a fusion protein including sarco/endoplasmic reticulum calcium ATPase, a fluorescence donor for FRET, and a fluorescence acceptor, one of the fluorescence donor and the fluorescence acceptor being linked to the N-terminus side of the ATPase, the other of the fluorescence donor and the fluorescence acceptor being inserted between the above one of the fluorescence donor and the fluorescence acceptor and the ATPase or being inserted in an amino acid sequence of the ATPase, the amino acid sequence corresponding to (i) amino acids 1 through 6 in SERCA2a, (ii) amino acids 369 through 380 in the SERCA2a or (iii) amino acids 572 through 583 in the SERCA2a.

### TECHNICAL FIELD

The present invention relates to (i) a fusion protein to serve as a probe for detecting kinetics of sarco/endoplasmic reticulum calcium ATPase and (ii) use of the fusion protein.

### BACKGROUND ART

Sarco/endoplasmic reticulum calcium ATPase (SERCA) is an intracellular calcium pump present on a membrane of an endoplasmic reticulum. SERCA takes a pivotal role in maintaining the intracellular calcium ion homeostasis. When SERCA activity is disturbed, it results in a disease such as heart failure, diabetes, cancer, or Alzheimer's disease. SERCA is also a gene responsible for hereditary heart disease.

Non Patent Literature 1 discloses a fluorescent probe of SERCA. This fluorescent probe is a probe that uses FRET (fluorescence resonance energy transfer). The fluorescent probe includes (i) a CFP (cyan fluorescent protein) fused with the N-terminus of SERCA as a FRET donor and (ii) a lysine residue at position 515, the lysine residue being labeled with FITC (fluorescein isothiocyanate) serving as a FRET acceptor.

### CITATION LIST

### Non-Patent Literature

Non Patent Literature 1
D. L. Winters, J. M. Autry, B. Svensson, D. D. Thomas, Biochemistry 2008, 47, 4246-4256

### SUMMARY OF INVENTION

### Technical Problem

The fluorescent probe of Non Patent Literature 1 is, however, FITC-labeled and SERCA activity is deactivated in the probe. This means that conventional fluorescent probes cannot be used to observe kinetics of SERCA that maintains its activity.

The present invention has been accomplished in view of the above problem with conventional techniques. It is an object of the present invention to provide a fusion protein applicable as a FRET probe that allows kinetics of SERCA maintaining its activity to be observed.

### Solution to Problem

In order to solve the above problem, a fusion protein of the present invention is a fusion protein including: sarco/endoplasmic reticulum calcium ATPase; a fluorescence donor for FRET; and a fluorescence acceptor for FRET, one of the fluorescence donor and the fluorescence acceptor being linked to an N-terminus side of the sarco/endoplasmic reticulum calcium ATPase, the other of the fluorescence donor and the fluorescence acceptor being inserted between the one of the fluorescence donor and the fluorescence acceptor and the sarco/endoplasmic reticulum calcium ATPase or being inserted in an amino acid sequence of the sarco/endoplasmic reticulum calcium ATPase, the amino acid sequence corresponding to (i) amino acids 1 through 6 in SERCA2a, (ii) amino acids 369 through 380 in the SERCA2a, or (iii) amino acids 572 through 583 in the SERCA2a.

In the fusion protein of the present invention, the fluorescence donor and the fluorescence acceptor are not particularly limited to the specific examples below. The fusion protein of the present invention may preferably be arranged such that at least one of the fluorescence donor and the fluorescence acceptor is either (i) a fluorescent protein as a donor or an acceptor or (ii) a fluorescent substance as a donor or an acceptor, the fluorescent substance being bound specifically to a particular peptide sequence.

In the fusion protein of the present invention, the fluorescence donor and the fluorescence acceptor are not particularly limited to the specific examples below. The fusion protein of the present invention may preferably be arranged such that the fluorescence donor is a blue fluorescent protein; and the fluorescence acceptor is either (i) a yellow fluorescent protein or (ii) FlAsH specifically bound to tetra cystein-tag or an analog of the FlAsH.

The fusion protein of the present invention is not particularly limited to the specific examples below. The fusion protein of the present invention may preferably be arranged such that the other of the fluorescence donor and the fluorescence acceptor is inserted between the one of the fluorescence donor and the fluorescence acceptor and the N-terminus of the sarco/endoplasmic reticulum calcium ATPase or inserted at a position of the sarco/endoplasmic reticulum calcium ATPase, the position corresponding to a position between the amino acids 374 and 375 in the SERCA2a or between the amino acids 577 and 578 in the SERCA2a.

The fusion protein of the present invention is not particularly limited to the specific examples below. The present invention provides a fusion protein including: the amino acid sequence represented by one of SEQ ID NOs: 1 through 4; or an amino acid sequence in which one or several amino acids have been deleted, replaced, or added in the amino acid sequence represented by one of SEQ ID NOs: 1 through 4.

The present invention provides a polynucleotide encoding a fusion protein having any of the above arrangements.

The present invention is not particularly limited to the specific examples below. The present invention provides a polynucleotide including: the nucleotide sequence represented by one of SEQ ID NOs: 6 through 9; a nucleotide sequence in which one or several nucleotide sequences have been deleted, replaced, or added in the nucleotide sequence represented by one of SEQ ID NOs: 6 through 9; a nucleotide sequence that hybridizes, under a stringent condition, with a polynucleotide including a nucleotide sequence complementary to the nucleotide sequence represented by one of SEQ ID NOs: 6 through 9; or a nucleotide sequence that is at least 66% identical to the nucleotide sequence represented by one of SEQ ID NOs: 6 through 9.

The present invention also provides a vector including a polynucleotide of the present invention. The present invention further provides a transformant including either a polynucleotide of the present invention or a vector of the present invention.

The present invention also provides a method for observing behavior of sarco/endoplasmic reticulum calcium ATPase, the method including the step of: detecting, with use of a fusion protein of the present invention, an intensity of fluorescence from the fluorescence donor and an intensity of fluorescence from the fluorescence acceptor.

The present invention also provides a method for screening of a compound for which sarco/endoplasmic reticulum calcium ATPase is a target molecule, the method including the step of: comparing (i) a ratio between an intensity of fluorescence from the fluorescence donor and an intensity of fluorescence from the fluorescence acceptor for a case in which a test compound has been treated with use of a fusion protein of the present invention and (ii) the ratio for a case in which the test compound has not been treated with use of the fusion protein of the present invention.

The present invention also provides a kit for observing behavior of sarco/endoplasmic reticulum calcium ATPase, the kit including: a polynucleotide of the present invention.

The present invention also provides a method for designing a fusion protein including sarco/endoplasmic reticulum calcium ATPase, a fluorescence donor for FRET, and a fluorescence acceptor for FRET, the method designing the fusion protein such that one of the fluorescence donor and the fluorescence acceptor is linked to an N-terminus side of the sarco/endoplasmic reticulum calcium ATPase and that the other of the fluorescence donor and the fluorescence acceptor is inserted either between the one of the fluorescence donor and the fluorescence acceptor and the sarco/endoplasmic reticulum calcium ATPase or inserted in an amino acid sequence of the sarco/endoplasmic reticulum calcium ATPase, the amino acid sequence corresponding to (i) amino acids 1 through 10 in SERCA2a, (ii) amino acids 364 through 384 in the SERCA2a, or (iii) amino acids 567 through 587 in the SERCA2a.

### Advantageous Effects of Invention

The present invention can provide a fusion protein applicable in a FRET probe that allows kinetics of SERCA maintaining its activity to be observed.

### BRIEF DESCRIPTION OF DRAWINGS

(a) through (d) of FIG. 1 are diagrams illustrating some examples of a fusion protein of the present invention.

(a) through (e) of FIG. 2 are each a graph illustrating a change caused in FRET efficiency by addition of Tg to a transformant that expresses a FRET probe.

(a) through (d) of FIG. 3 are each a graph illustrating a change caused in FRET efficiency by a change in calcium concentration of a cell that expresses a FRET probe.

(a) through (c) of FIG. 4 are each a graph illustrating a FRET efficiency of a FRET probe which FRET efficiency is achieved when the FRET probe has been fixed to a structure.

(a) and (b) of FIG. 5 are each a graph illustrating a relation between a change in FRET efficiency of F-L577 and accumulation of Ca²⁺ in an ER.

(a) and (b) of FIG. 6 are each a graph showing both (i) a first derivative of the FRET efficiency of F-L577 and (ii) a first derivative of the accumulation of Ca²⁺ in an ER, the FRET efficiency and the accumulation being both indicated in (a) and (b) of FIG. 5.

(a) of FIG. 7 is a graph illustrating a relation between an ATP concentration and a change in FRET efficiency of F-L577, and (b) of FIG. 7 is a graph illustrating a relation between an ATP concentration and accumulation of Ca²⁺ in an ER.

FIG. 8 is a graph illustrating a correlation between the FRET efficiency of F-L577 and accumulation of Ca²⁺ in an ER.

### DESCRIPTION OF EMBODIMENTS

### Fusion Protein

The present invention provides a fusion protein including (i) sarco/endoplasmic reticulum calcium ATPase, (ii) a fluorescence donor for FRET, and (iii) a fluorescence acceptor for FRET. One of the fluorescence donor and the fluorescence acceptor is linked with the N-terminus side of the sarco/endoplasmic reticulum calcium ATPase, whereas the other of the fluorescence donor and the fluorescence acceptor is inserted either between the above one of the fluorescence donor and the fluorescence acceptor and the sarco/endoplasmic reticulum calcium ATPase or in an amino acid sequence of the sarco/endoplasmic reticulum calcium ATPase, corresponding to (i) amino acids 1 through 6, (ii) amino acids 369 through 380, or (iii) amino acids 572 through 583 in SERCA2a (SEQ ID NO: 11; see P. Vangheluwe et al., Cell Calcium 38 [2005] 291-302).

The terms “sarco/endoplasmic reticulum calcium ATPase” and “SERCA” as used in the present specification each refer to a protein that belongs to the SERCA (sarco/endoplasmic reticulum Ca²⁺-ATPase) family. Known examples of proteins belonging to the SERCA family include SERCA1a, SERCA1b, SERCA2a, SERCA2b, SERCA3a, SERCA3b, and SERCA3c. The sarco/endoplasmic reticulum calcium ATPase of the present invention is not particularly limited, provided that it is a protein that is homologous to any of the above proteins. The sarco/endoplasmic reticulum calcium ATPase is a protein having a homology of (i) preferably at least 70%, (ii) more preferably 80% or greater, (iii) even more preferably 90% or greater, or (iv) particularly preferably 95% or greater, with a publicly known protein belonging to the SERCA family.

The fluorescence donor of the present invention is not particularly limited, provided that it is (i) a molecule that functions as a FRET donor with respect to the fluorescence acceptor of the present invention or (ii) a precursor of the molecule. In other words, the fluorescence donor is preferably (i) a molecule having an excitation spectrum that overlaps with the excitation spectrum of the fluorescence acceptor or (ii) a precursor of the molecule. Preferably, the fluorescence donor includes, for example, (i) a fluorescent protein as a donor or (ii) a fluorescent substance as a donor, the fluorescent substance being bound specifically to a particular peptide sequence.

The term “donor” as used in the present specification refers to a molecule generally applicable as a molecule that generates excitation energy in the FRET technique.

Examples of the fluorescent protein as a donor, the fluorescent protein being applicable as the fluorescence donor of the present invention, include a blue fluorescent protein and a yellow fluorescent protein. Specific examples of the fluorescent protein include CFP, ECFP, YFP, and Venus.

Examples of the particular peptide sequence to which the fluorescent substance as a donor is specifically bound include tetra cystein-tag (TC-tag), HaloTag (registered trademark) (labeling reagents: many kinds of labeling reagents from Promega are applicable), SNAP-tag, CLIP-tag, ACP-tag, MCP-tag (labeling: many kinds of labeling reagents from New Englnad Biolabs are applicable), and fluorogen activating proteins (FAPs) (see Nat. Biotechnol. 2008; 26(2): 235-240). The peptide sequence is, however, not limited to the above. TC-tag is, for example, a peptide sequence to which FlAsH (that is, a fluorescent substance having a MW of 664.5) or an analog thereof is specifically bindable.

The fluorescence acceptor of the present invention is not particularly limited, provided that it is (i) a molecule that functions as a FRET acceptor with respect to the fluorescence donor of the present invention or (ii) a precursor of the molecule. In other words, the fluorescence acceptor is preferably (i) a molecule having an excitation spectrum that overlaps with the excitation spectrum of the fluorescence donor or (ii) a precursor of the molecule. Preferably, the fluorescence acceptor includes, for example, (i) a fluorescent protein as an acceptor or (ii) a fluorescent substance as an acceptor, the fluorescent substance being bound specifically to a particular peptide sequence.

The term “acceptor” as used in the present specification refers to a molecule typically applicable as a molecule that emits fluorescence in response to excitation energy from a donor in the FRET technique.

Examples of the fluorescent protein as an acceptor, the fluorescent protein being applicable as the fluorescence acceptor of the present invention, include a blue fluorescent protein and a yellow fluorescent protein. Specific examples of the fluorescent protein include CFP, ECFP, YFP, and Venus.

Examples of the particular peptide sequence to which the fluorescent substance as an acceptor is specifically bound include tetra cystein-tag (TC-tag), HaloTag (registered trademark) (labeling reagents: many kinds of labeling reagents from Promega are applicable), SNAP-tag, CLIP-tag, ACP-tag, MCP-tag (labeling: many kinds of labeling reagents from New Englnad Biolabs are applicable), and fluorogen activating proteins (FAPs) (see Nat. Biotechnol. 2008; 26(2): 235-240). The peptide sequence is, however, not limited to the above.

The combination of the fluorescence donor and the fluorescence acceptor is not particularly limited, provided that it is such that the fluorescence donor and the fluorescence acceptor function respectively as a fluorescence donor for FRET and a fluorescence acceptor for FRET in combination. Exemplary combinations include (i) a combination of a blue fluorescent protein (for example, ECFP) and a yellow fluorescent protein (for example, Venus) and (ii) a combination of a blue fluorescent protein and FlAsH bound to tetra cystein-tag or an analog thereof.

One of the fluorescence donor and the fluorescence acceptor is linked to the N-terminus side of the sarco/endoplasmic reticulum calcium ATPase. The above one of the fluorescence donor and the fluorescence acceptor may be linked to the N-terminus of the sarco/endoplasmic reticulum calcium ATPase via a linker. The linker can be, for example, a peptide, which preferably includes 1 to 5 amino acids, or more preferably includes 1 to 3 amino acids.

The amino acid sequence of the sarco/endoplasmic reticulum calcium ATPase, corresponding to (i) amino acids 1 through 6, (ii) amino acids 369 through 380, or (iii) amino acids 572 through 583 in SERCA2a refers to an amino acid sequence of the sarco/endoplasmic reticulum calcium ATPase, corresponding to the above amino acids in the SERCA2a in view of homology between the sarco/endoplasmic reticulum calcium ATPase of the present invention and the SERCA2a in terms of an amino acid sequence or conformation.

In the case where the sarco/endoplasmic reticulum calcium ATPase is, for example, SERCA1a (SEQ ID NO: 12; see C. Toyoshima et al., Nature 405 [2000] 647-655), (i) an amino acid sequence in the SERCA1a which amino acid sequence corresponds to the amino acids 1 through 6 of the SERCA2a is of amino acids 1 through 6, (ii) an amino acid sequence in the SERCA1a which amino acid sequence corresponds to the amino acids 369 through 380 of the SERCA2a is of amino acids 369 through 380, and (iii) an amino acid sequence in the SERCA1a which amino acid sequence corresponds to the amino acids 572 through 583 of the SERCA2a is of amino acids 573 through 584.

The other of the fluorescence donor and the fluorescence acceptor is preferably inserted between the one of the fluorescence donor and the fluorescence acceptor and the sarco/endoplasmic reticulum calcium ATPase or inserted in an amino acid sequence of the sarco/endoplasmic reticulum calcium ATPase, corresponding to (i) the amino acids 1 through 5, (ii) the amino acids 370 through 379 or (iii) the amino acids 573 through 582 in SERCA2a.

The other of the fluorescence donor and the fluorescence acceptor is more preferably inserted between the one and the sarco/endoplasmic reticulum calcium ATPase, or inserted in an amino acid sequence of the sarco/endoplasmic reticulum calcium ATPase, corresponding to (i) the amino acids 1 through 4 (ii) the amino acids 371 through 378, or (iii) the amino acids 574 through 581 in SERCA2a.

The other of the fluorescence donor and the fluorescence acceptor is even more preferably inserted between the one of the fluorescence donor and the fluorescence acceptor and the sarco/endoplasmic reticulum calcium ATPase, or inserted in an amino acid sequence of the sarco/endoplasmic reticulum calcium ATPase, corresponding to (i) the amino acids 1 through 3, (ii) the amino acids 372 through 377 or (iii) the amino acids 575 through 580 in SERCA2a.

The other of the fluorescence donor and the fluorescence acceptor is yet even more preferably inserted between the one of the fluorescence donor and the fluorescence acceptor and the sarco/endoplasmic reticulum calcium ATPase, inserted between the amino acids 1 and 2 in SERCA2a of the sarco/endoplasmic reticulum calcium ATPase, or inserted in an amino acid sequence of the sarco/endoplasmic reticulum calcium ATPase, corresponding to (i) the amino acids 373 through 376 or (ii) the amino acids 576 through 579 in the SERCA2a.

The other of the fluorescence donor and the fluorescence acceptor is most preferably inserted between the one of the fluorescence donor and the fluorescence acceptor and the sarco/endoplasmic reticulum calcium ATPase, inserted at a position of the sarco/endoplasmic reticulum calcium ATPase, corresponding to the position between the amino acids 374 and 375 in SERCA2a, or inserted at a position of the sarco/endoplasmic reticulum calcium ATPase, corresponding to the position between the amino acids 577 and 578 in SERCA2a.

The above arrangement allows the fusion protein of the present invention to retain activity as sarco/endoplasmic reticulum calcium ATPase.

SERCA changes its structure along with an activity change. SERCA has the following main structures: E1-2Ca²⁺, E1-ATP, E2P, and E2 (see C. Toyoshima, Annu. Rev. Biochem. 2004, 73:269-92; C. Toyoshima, Biochim. Biophys. Acta 1793 [2009] 941-946; T. L. Sorensen et al., Science 304 [2004] 1672-1675; C. Toyoshima, T. Mizutani, Nature 430 [2004] 529-535; C. Toyoshima et al., Proc. Natl. Acad. Sci. U.S.A. 104 [2007] 19831-19836). E1-2Ca²⁺ is SERCA having uptaken two Ca²⁺ molecules. When ATP is further bound to E1-2Ca²⁺, E1-2Ca²⁺ becomes E1-ATP. E1-ATP becomes E2P when ATP is degraded and Ca²⁺ is released. When phosphate group is removed from E2P, E2P becomes E2. E2 uptakes Ca²⁺ therein, thereby becoming E1-2Ca²⁺.

The fusion protein of the present invention changes its structure along with a change in activity of the sarco/endoplasmic reticulum calcium ATPase, and changes the distance between the fluorescence donor and the fluorescence acceptor along with the structural change. This indicates that a FRET probe including the fusion protein of the present invention can take different structures, which are different from one another in terms of the distance between the fluorescence donor and the fluorescence acceptor and which are thus different from one another in FRET efficiency. Determining in advance respective FRET efficiencies of the different structures that a FRET probe can take and detecting a FRET efficiency under a certain condition, therefore, allows detection of what structure the FRET probe has under that certain condition. The FRET efficiency of a FRET probe has a value that varies according to the composition of the FRET probe.

The term “FRET efficiency” refers to an efficiency in transferring excitation energy from a fluorescence donor to a fluorescence acceptor. The FRET efficiency can be expressed as, for example, the ratio between (i) the intensity of fluorescence from a fluorescence donor and (ii) that of fluorescence from a fluorescence acceptor.

The fusion protein of the present invention is, as described above, applicable to a FRET probe that uses the fluorescence resonance energy transfer (FRET) technique. The fusion protein of the present invention is particularly applicable to a FRET probe that allows observation of kinetics of SERCA that maintains its activity.

Moreover, the fusion protein of the present invention is applicable to a FRET probe that visualizes, as a change in FRET efficiency, a change in structure of sarco/endoplasmic reticulum calcium ATPase, that is, a change in activity thereof.

The fusion protein of the present invention retains the activity as sarco/endoplasmic reticulum calcium ATPase in a living cell. Thus, the fusion protein of the present invention is applicable to a FRET probe for making it possible to easily visualize kinetics of sarco/endoplasmic reticulum calcium ATPase that maintains its activity with use of the FRET technique by expressing the fusion protein in a living cell. The present invention is further useful in analyzing a correlation between the structure and function of sarco/endoplasmic reticulum calcium ATPase. The present invention is particularly useful in examining what structural change occurs in SERCA when the state of the SERCA changes from one to the other.

The present invention is, therefore, suitably applicable as a sarco/endoplasmic reticulum calcium ATPase kinetics indicator. The present invention is further extremely useful not only in research on kinetics of SERCA, but also in, for example, screening of a molecular target drug for treating, alleviating, or preventing SERCA-related diseases and diagnosis of such diseases.

SERCA changes its activity along with a change in calcium ion concentration. The fusion protein of the present invention is thus applicable in, for example, a FRET probe for detecting a calcium ion level and a FRET probe for detecting a change in calcium ion concentration.

The term “fusion protein” as used in the present specification may refer to a protein including variously derived proteins or polypeptides that are artificially linked to one another.

The fusion protein of the present invention as such is applicable as a FRET probe in the case where the fluorescence donor and the fluorescence acceptor are respectively (i) a molecule that functions as a FRET donor and (ii) a molecule that functions as a FRET acceptor. In the case where the fluorescence donor and the fluorescence acceptor are respectively (i) a precursor of a molecule that functions as a FRET donor and (ii) a precursor of a molecule that functions as a FRET acceptor, the fusion protein of the present invention becomes applicable as a FRET probe after the precursors (i) and (ii) are converted respectively into (i) a molecule that functions as a FRET donor and (ii) a molecule that functions as a FRET acceptor. In the case where one of the fluorescence donor and the fluorescence acceptor is the corresponding one of the above precursors (i) and (ii), the fusion protein of the present invention becomes applicable as a FRET probe after the above corresponding one of the precursors (i) and (ii) is converted into the corresponding one of (i) a molecule that functions as a FRET donor and (ii) a molecule that functions as a FRET acceptor.

The term “polypeptide” as used in the present specification is interchangeable with “peptide” and “protein”. The polypeptide of the present invention may be chemically synthesized or isolated from a natural source. An “isolated” polypeptide or protein is intended to mean a polypeptide or protein taken from an environment in which it naturally occurs. For example, a recombinant polypeptide or protein expressed in a host cell for production is construed as having been isolated similarly to a natural or recombinant polypeptide or protein substantially purified by any suitable technique.

Polypeptides as constituent elements of the fusion protein include in its scope (i) a natural purified product, (ii) a product produced through a chemical synthesis procedure, and (iii) a product produced by a recombination technique from a prokaryotic or eukaryotic host (for example, a bacterial cell, a yeast cell, a higher-plant cell, an insect cell, or a mammalian cell).

The fusion protein of the present invention and a polypeptide as an individual constituent element may each further include an additional peptide. Examples of such an additional peptide include an epitope-tagging peptide such as His tag, HA tag, Myc tag, and Flag tag. The fusion protein of the present invention may be modified into a preferable form and expressed recombinantly. The fusion protein of the present invention may further include, for example, a region of a particular amino acid(s), particularly a charged amino acid(s), at the N-terminus or C-terminus. This can improve stability, durability and the like of the fusion protein in a host cell and during purification, an operation subsequent to purification, and storage, for example.

In one embodiment, the fusion protein of the present invention is preferably (i) a fusion protein including the amino acid sequence represented by one of SEQ ID NOs: 1 through 4 or (ii) a mutant thereof. The mutant is preferably a fusion protein including an amino acid sequence in which one or several amino acids have been deleted, replaced, or added in the amino acid sequence represented by one of SEQ ID NOs: 1 through 4.

The term “mutant” as used in the present specification in relation to a fusion protein, a polypeptide, and a protein is intended to mean a polypeptide or protein with at least one of its original amino acids having undergone point mutation, insertion, inversion, repeat, deletion, and/or type replacement.

The above mutant is, for example, a mutant having a mutation such as deletion, insertion, inversion, repeat, type replacement (for example, replacement of a hydrophilic residue with another residue; however, a highly hydrophilic residue is normally not replaced with a highly hydrophobic residue), and point mutation. Examples of replacement of an amino acid include a case of replacing a neutral amino acid in a polypeptide with another neutral amino acid.

It is well-known in the related technical field that some amino acids in an amino acid sequence of a polypeptide can be easily modified without significantly influencing the structure or function of that polypeptide. It is also well-known in the related technical field that there is also present, not only an artificially modified mutant, a mutant found in a natural protein which mutant has a structure or function that has not been significantly changed from that of the natural protein.

Persons skilled in the art can use a well-known technique to easily mutate one or more amino acids in an amino acid sequence of a polypeptide. Persons skilled in the art can use, for example, a publicly known point mutagenesis to mutate any base of a polynucleotide encoding a polypeptide. Persons skilled in the art can also design a primer(s) corresponding to any site of a polynucleotide encoding a polypeptide to prepare a deletion mutant or addition mutant. Further, persons skilled in the art can use a method described in the present specification to easily determine whether a prepared mutant has a desired activity.

The expression “in which one or several amino acids have been deleted, replaced, or added” refers to the state of amino acids having been deleted, replaced, or added in such a number (preferably ten or fewer, more preferably seven or fewer, or most preferably five or fewer) that can be deleted, replaced, or added by a publicly known mutant protein preparation method such as site-directed mutagenesis. Such a mutant protein is, as described above, not limited to a protein having a mutation that has been artificially introduced by a publicly known mutant protein preparation method, and may thus be a naturally occurring mutant protein that has been isolated and purified.

The fusion protein of the present invention is not particularly limited, provided that it is a polypeptide including amino acids linked to one another to form a peptide bond. The fusion protein is, however, not limited to such a polypeptide, and may be a conjugated polypeptide including a structure other than a polypeptide. The expression “structure other than a polypeptide” as used in the present specification refers to, for example, a sugar chain or an isoprenoid group, and is not particularly limited to any specific one.

The fusion protein of the present invention may be (i) in the state where a below-described polynucleotide of the present invention (that is, a gene that encodes the fusion protein of the present invention) has been introduced into a host cell so that the fusion protein has been expressed intracellularly, or may be (ii) isolated and purified from a cell, a tissue or the like.

In another embodiment, a mutant of the fusion protein of the present invention is preferably encoded by a polynucleotide including a nucleotide sequence in which one or more nucleotide sequences have been deleted, replaced, or added in the nucleotide sequence represented by one of SEQ ID NOs: 6 through 9.

In another embodiment, a mutant of the fusion protein of the present invention is preferably encoded by a polynucleotide that hybridizes, under a stringent condition, with a polynucleotide including a nucleotide sequence complementary to the nucleotide sequence represented by one of SEQ ID NOs: 6 through 9.

The above hybridization can be performed by a known method such as a method described in Sambrook et al., Molecular Cloning, A Laboratory Manual, 2nd Ed., Cold Spring Harbor Laboratory (1989). Normally, a higher temperature or a lower salt concentration causes a higher stringency (which makes hybridization more difficult), and thus makes it possible to obtain a more homologous polynucleotide. A suitable hybridization temperature varies according to, for example, the nucleotide sequence and its length. For instance, a temperature of 50° or lower is preferable in the case where a probe to be used is a 18 base length DNA fragment encoding six amino acids.

The expression “stringent condition” as used in the present specification refers to a condition involving (i) an overnight incubation at 42° C. in a hybridization solution (including 50% formamide, 5×SSC [150 mM of NaCl and 15 mM of trisodium citrate], 50 mM of sodium phosphate (pH 7.6), 5×Denhardt's solution, 10% dextran sulfate, and 20 μg/ml of denatured sheared salmon sperm DNA) and (ii) subsequent washing of a filter at approximately 65° C. in 0.1×SSC.

In another embodiment, a mutant of the fusion protein of the present invention is preferably encoded by a polynucleotide including a nucleotide sequence that is (i) at least 66% identical, (ii) preferably at least 80% identical, or (iii) more preferably at least 85%, 90%, 92%, 95%, 96%, 97%, 98%, or 99% identical to the nucleotide sequence represented by one of SEQ ID NOs: 6 through 9.

[Polynucleotide]

The present invention further provides a polynucleotide encoding the fusion protein of the present invention. The polynucleotide of the present invention encodes any of the fusion proteins described above.

The term “polynucleotide” as used in the present specification is interchangeable with “gene”, “nucleic acid”, and “nucleic acid molecule”, and is intended to mean a polymer of nucleotides. The term “nucleotide sequence” as used in the present specification is interchangeable with “nucleic acid sequence” and “base sequence”, and is expressed as a sequence of deoxyribonucleotides (each abbreviated to A, G, C, or T) or ribonucleotides (each abbreviated to C, A, G, or U). The expression “polynucleotide including the nucleotide sequence represented by SEQ ID NO: 6 or a fragment of the polynucleotide” is intended to mean (i) a polynucleotide including the sequence represented by the individual deoxynucleotides A, G, C and/or T in SEQ ID NO: 6 or (ii) a fragment of the polynucleotide.

The polynucleotide of the present invention can exist in the form of an RNA (for example, mRNA) or in the form of a DNA (for example, cDNA or genomic DNA). The DNA may be a double-strand DNA or a single-strand DNA. The single-strand DNA or RNA may be a coding strand (also known as a sense strand) or a noncoding strand (also known as an antisense strand).

In one embodiment, the polynucleotide of the present invention is preferably (i) a polynucleotide including the nucleotide sequence represented by one of SEQ ID NOs: 6 through 9 or (ii) a mutant of the polynucleotide.

In one embodiment, a mutant of the polynucleotide of the present invention is preferably one of the following polynucleotides:

a polynucleotide including a nucleotide sequence in which one or several nucleotide sequences have been deleted, replaced, or added in the nucleotide sequence represented by one of SEQ ID NOs: 6 through 9;

a polynucleotide that hybridizes, under a stringent condition, with a polynucleotide including a nucleotide sequence complementary to the nucleotide sequence represented by one of SEQ ID NOs: 6 through 9; and

a polynucleotide including a nucleotide sequence that is (i) at least 66% identical, (ii) preferably at least 80% identical, or (iii) more preferably at least 85%, 90%, 92%, 95%, 96%, 97%, 98%, or 99% identical to a nucleotide sequence represented by one of SEQ ID NOs: 6 through 9.

The polynucleotide of the present invention may include a sequence such as (i) a sequence of an untranslated region (UTR) and (ii) a vector sequence (for example, a vector sequence for expression).

The polynucleotide of the present invention is subcloned into, for example, an expression vector to prepare a vector (plasmid) for expressing a fusion protein. Introducing this vector into a cell allows intracellular expression of a fusion protein that the polynucleotide encodes.

The polynucleotide of the present invention can include, integrated therein upstream from a region for encoding a fusion protein, a promoter sequence or the like for intracellular expression of the fusion protein.

The polynucleotide of the present invention can include, added thereto, a polynucleotide for encoding a tag sequence such as His tag, HA tag, Myc tag, and Flag tag.

The polynucleotide of the present invention can be produced by, for example, linearly linking polynucleotides each for encoding a polypeptide as an individual constituent element.

[Vector]

The present invention provides a vector for use in producing the fusion protein of the present invention. The vector of the present invention may be (i) a vector for a recombinant expression in a host cell or (ii) a vector for use in in-vitro production of the fusion protein.

The vector of the present invention is not particularly limited to any specific one as long as it includes the polynucleotide of the present invention. The vector of the present invention is, for example, a vector including, inserted therein, cDNA (that is, a form of polynucleotide) for encoding the polypeptide of the present invention. The vector is prepared by using, for example, a plasmid, a phage, or a cosmid. The method is, however, not particularly limited to any specific one.

The vector is not particularly limited in terms of its specific kind. It is preferable to select as appropriate a vector such as (i) a vector that can introduce a polynucleotide of interest into a host cell and (ii) a vector that can express, in a host cell, a fusion protein encoded by a polynucleotide. Examples of the vector include (i) a plasmid derived from Escherichia coli, (ii) a plasmid that can express a protein in an animal cell, and (iii) an animal virus.

The vector preferably includes, integrated therein, a proper promoter sequence together with the polynucleotide of the present invention. The promoter sequence is preferably selected as appropriate according to the kind of the host cell for expression of the polynucleotide of the present invention.

The present invention can involve any suitable promoter corresponding to a host for use in gene expression. Examples of the promoter include (i) a trp promoter, a lac promoter, a recA promoter, a λPL promoter, and an lpp promoter in the case where the host is Escherichia coli, and (ii) an SRα promoter, an SV40 promoter, an LTR promoter, a CMV promoter, and an HSV-TK promoter in the case where the host is an animal cell.

The vector of the present invention can further include, other than the above, an enhancer, a splicing signal, a poly-A additional signal, a selective marker, an SV40 replication origin and/or the like as desired that are publicly known in the related technical field. Further, according to need, a fusion protein encoded by the polynucleotide of the present invention can also be expressed as linked with another protein. Such proteins linked with each other can be separated into the individual proteins by cleaving the linked proteins with use of an appropriate protease.

The vector of the present invention preferably includes at least one selective marker. The selective marker is, for example, a publicly known drug resistant gene. The use of a selective marker makes it possible to determine whether the polynucleotide of the present invention has been introduced into a host cell and whether the polynucleotide is certainly expressed in the host cell.

Introducing the vector of the present invention into an organism or cell allows the fusion protein of the present invention to be expressed in that organism or cell.

[Transformant]

The present invention provides a transformant including the polynucleotide of the present invention. The term “transformant” includes in its concept not only a cell, a tissue, an organ and the like, but also an individual organism.

The transformant can be produced by, for example, transforming a host cell with use of the vector of the present invention.

The terms “cell” and “host cell” as used in the present specification each refer to not only a cell in an organism (for example, a prokaryotic cell, a yeast cell, an insect cell, a plant cell, and a mammalian cell including a human cell), but also a cultured cell (that is, a prokaryotic cell and a eukaryotic cell) that maintains its original function. The terms “cell” and “host cell” each include in its scope: a primary cultured cell; a continuous cell line; an established cell line; a transformed cell line; an isolated embryonic stem (ES) cell; a tissue stem cell; a cell provided with differentiation pluripotency through an artificial manipulation such as genetic engineering (the cell including an induced pluripotent stem (iPS) cell in its scope and also including, in a non-limitative manner, a cell such as a cell that has differentiated from an iPS cell); and a cell that has been transplanted into an individual organism or that has infected an individual organism. The terms “cell” and “host cell” each further include in its concept a tissue, an organ, and an individual organism itself.

The method for introducing the vector into a host cell, that is, the transformation method, is not particularly limited to any specific one. The method can suitably be a conventionally publicly known method such as electroporation, calcium phosphate method, liposome method, and DEAE dextran method.

The transformant of the present invention is preferably a transformant that can express the fusion protein of the present invention. The transformant is preferably a eukaryotic cultured cell, or more preferably a cultured cell derived from a human. This arrangement allows activity to be retained of a fusion protein expressed in the transformant, and thus makes it possible to observe kinetics of sarco/endoplasmic reticulum calcium ATPase in a living cell.

[Method for Producing Fusion Protein]

The fusion protein of the present invention can be produced by expression in the transformant of the present invention. The production of fusion protein can also include further purifying the fusion protein expressed in the transformant.

The fusion protein expressed in the transformant is purified by a method that varies according to, for example, the host cell used and properties of the fusion protein. Using a tag, for example, makes it relatively easy to purify a fusion protein of interest. The fusion protein of the present invention can be purified by (i) preparing a cell extract from a host cell by a known method and then (ii) purifying the fusion protein from the cell extract by a known method.

The fusion protein of the present invention can also be produced by (i) preparing polypeptides as the respective constituent elements with use of a known chemical synthesis technique by chemical synthesis or the like and then (ii) linking the polypeptides to one another. The fusion protein can alternatively be produced in vitro with use of the above-described vector in, for example, a known cell-free protein synthesis system.

[Method for Observing Behavior of Sarco/Endoplasmic Reticulum Calcium ATPase]

The present invention provides a method for observing behavior of sarco/endoplasmic reticulum calcium ATPase. This behavior observation method includes a step of detecting, with use of the fusion protein of the present invention, the intensity of fluorescence from the fluorescence donor and that of fluorescence from the fluorescence acceptor. The fusion protein is preferably a fusion protein expressed and remaining in the transformant of the present invention.

The present invention makes it possible to calculate the ratio between (i) the intensity of fluorescence from the fluorescence donor of the fusion protein and (ii) the intensity of fluorescence from the fluorescence acceptor of the fusion protein. The present invention, in other words, makes it possible to detect the FRET efficiency of the fusion protein. Determining in advance respective FRET efficiencies of the different structures that the fusion protein can take and detecting a FRET efficiency under a certain condition allows detection of what structure the fusion protein has under that certain condition.

Detecting, with use of the present invention, a change in FRET efficiency through a transition from a first state to a second state makes it possible to detect how the fusion protein has changed its structure.

The present invention, as described above, makes it possible to observe behavior of SERCA that maintains its activity. The present invention therefore allows, for example, (i) screening of molecular target drugs for treating SERCA-related diseases and (ii) diagnosis of such diseases.

[Screening Method]

The present invention provides a method for screening of a compound for which sarco/endoplasmic reticulum calcium ATPase is a target molecule. This screening method includes a step of, with use of the fusion protein of the present invention, comparing (i) the ratio between the intensity of fluorescence from the fluorescence donor and that of fluorescence from the fluorescence acceptor for the case in which a test compound has been treated with (ii) the same ratio for the case in which it has not been treated. The fusion protein is preferably a fusion protein expressed and remaining in the transformant of the present invention.

If comparison gives values different from each other between (i) the FRET efficiencies for the case in which a test compound has been treated and (ii) the same for the case in which it has not been treated, that test compound probably changes the structure of the fusion protein. Such a test compound is probably a compound that influences the structure of sarco/endoplasmic reticulum calcium ATPase and further influences its activity. In the above case, the test compound can be determined to be a compound that can influence the structure and activity of sarco/endoplasmic reticulum calcium ATPase.

In other words, the present invention may further include a step of, if the ratio for the case in which a test compound has been treated is different from the ratio for the case in which it has not been treated, selecting that test compound as a candidate compound for a compound for which sarco/endoplasmic reticulum calcium ATPase is a target molecule.

Sarco/endoplasmic reticulum calcium ATPase is known to be a gene responsible for hereditary heart disease, and is also known to have an activity related to diseases such as heart failure, diabetes, cancer, and Alzheimer's disease. This indicates that a compound for which sarco/endoplasmic reticulum calcium ATPase is a target molecule can be a candidate for a drug that is useful in, for example, treating and preventing diseases, symptoms and the like to which sarco/endoplasmic reticulum calcium ATPase is related.

[Kit]

The present invention also provides a kit including the polynucleotide of the present invention. The polynucleotide may be included in the form of (i) a vector including the polynucleotide or (ii) a transformant including the polynucleotide.

The kit of the present invention is a kit for use of the fusion protein of the present invention. The kit may be, for example, (i) a kit for observing behavior of sarco/endoplasmic reticulum calcium ATPase or (ii) a kit for screening of a compound for which sarco/endoplasmic reticulum calcium ATPase is a target molecule. The kit of the present invention is suitably applicable for the behavior observation method and screening method described above.

The kit of the present invention may be a kit for detecting a change in intracellular calcium concentration.

The kit of the present invention may, in addition to the polynucleotide of the present invention, further include, for example, (i) a plasmid for inserting the polynucleotide to produce a vector and/or (ii) a host cell for transforming the vector. The kit of the present invention may include the polynucleotide of the present invention in the form of a vector, and further include, for example, a host cell for transforming the vector. The kit of the present invention may include the polynucleotide of the present invention in the form of a transformant, and further include a reagent, a control compound and/or the like for use in the behavior observation method or screening method. The kit may further be provided with an instruction manual for the kit.

[Method for Designing Fusion Protein]

The present invention also provides a method for designing a fusion protein including sarco/endoplasmic reticulum calcium ATPase, a fluorescence donor for FRET, and a fluorescence acceptor for FRET.

In the designing method, a fusion protein is designed such that one of the fluorescence donor and the fluorescence acceptor is linked to the N-terminus side of the sarco/endoplasmic reticulum calcium ATPase and that the other of the fluorescence donor and the fluorescence acceptor is inserted between the above one linked to the N-terminus side of the sarco/endoplasmic reticulum calcium ATPase and the sarco/endoplasmic reticulum calcium ATPase or inserted in an amino acid sequence of the sarco/endoplasmic reticulum calcium ATPase, corresponding to (i) amino acids 1 through 6, (ii) amino acids 369 through 380, or (iii) amino acids 572 through 583 in SERCA2a.

Examples of the sarco/endoplasmic reticulum calcium ATPase, the fluorescence donor, and the fluorescence acceptor include those mentioned above.

In the designing method, a fusion protein is preferably designed such that the other of the fluorescence donor and the fluorescence acceptor is inserted between the one of the fluorescence donor and the fluorescence acceptor and the sarco/endoplasmic reticulum calcium ATPase, or inserted in an amino acid sequence of the sarco/endoplasmic reticulum calcium ATPase, corresponding to (i) the amino acids 1 through 5, (ii) the amino acids 370 through 379 or (iii) the amino acids 573 through 582 in SERCA2a.

In the designing method, a fusion protein is more preferably designed such that the other of the fluorescence donor and the fluorescence acceptor is inserted between the one of the fluorescence donor and the fluorescence acceptor and the sarco/endoplasmic reticulum calcium ATPase, or inserted in an amino acid sequence of the sarco/endoplasmic reticulum calcium ATPase, corresponding to (i) the amino acids 1 through 4, (ii) the amino acids 371 through 378 or (iii) the amino acids 574 through 581 in SERCA2a.

In the designing method, a fusion protein is even more preferably designed such that the other of the fluorescence donor and the fluorescence acceptor is inserted between the one of the fluorescence donor and the fluorescence acceptor and the sarco/endoplasmic reticulum calcium ATPase, or inserted in an amino acid sequence of the sarco/endoplasmic reticulum calcium ATPase, corresponding to (i) the amino acids 1 through 3, (ii) the amino acids 372 through 377 or (iii) the amino acids 575 through 580 in SERCA2a.

In the designing method, a fusion protein is yet even more preferably designed such that the other of the fluorescence donor and the fluorescence acceptor is inserted between (i) the one of the fluorescence donor and the fluorescence acceptor and the sarco/endoplasmic reticulum calcium ATPase, or inserted at a position between the amino acids of the sarco/endoplasmic reticulum calcium ATPase, corresponding to the amino acids 1 and 2 in SERCA2a, or inserted in an amino acid sequence of the sarco/endoplasmic reticulum calcium ATPase, corresponding to the amino acids 373 through 376 in the SERCA2a, or inserted in the amino acids 576 through 579 in the SERCA2a.

In the designing method, a fusion protein is most preferably designed such that the other of the fluorescence donor and the fluorescence acceptor is inserted at a position corresponding to a position that is (i) between the one of the fluorescence donor and the fluorescence acceptor and the sarco/endoplasmic reticulum calcium ATPase or (ii) between the amino acids of the sarco/endoplasmic reticulum calcium ATPase, corresponding to the amino acids 374 and 375 in SERCA2a or the amino acids 577 and 578 in the SERCA2a.

The designing method above makes it possible to design a fusion protein applicable as a FRET probe that allows kinetics of SERCA maintaining its activity to be observed.

The present invention is not limited to the embodiments above or to the Examples below.

### Examples

### 1: Preparation of Expression Vector

Expression vectors for expressing the respective FRET probes (fusion proteins) below were prepared. (a) through (d) of FIG. 1 illustrate respective structures of the FRET probes. (a) through (d) of FIG. 1 are diagrams illustrating some examples of the fusion protein of the present invention.

(1) TdCV-s (SEQ ID NO: 1): A FRET probe with (i) ECFP (fluorescence donor) linked with the N-terminus of SERCA2a (sarco/endoplasmic reticulum calcium ATPase) and (ii) Venus (fluorescence acceptor) inserted between the C-terminus of the ECFP and the N-terminus of the SERCA2a (see (a) of FIG. 1)

(2) V-G374 (SEQ ID NO: 2): A FRET probe with (i) ECFP linked with the N-terminus of SERCA2a and (ii) Venus inserted between amino acids 374 and 375 of the SERCA2a (see (b) of FIG. 1)

(3) V-L577 (SEQ ID NO: 3): A FRET probe with (i) ECFP linked with the N-terminus of SERCA2a and (ii) Venus inserted between amino acids 577 and 578 of the SERCA2a (see (c) of FIG. 1)

(4) F-L577 (SEQ ID NO: 4): A FRET probe with (i) ECFP linked with the N-terminus of SERCA2a and (ii) TC-tag inserted between amino acids 577 and 578 of the SERCA2a (see (d) of FIG. 1)

(5) V-G519 (SEQ ID NO: 5): A FRET probe with (i) ECFP linked with the N-terminus of SERCA2a and (ii) Venus inserted between amino acids 519 and 520 of the SERCA2a (not shown)

Expression vectors for expressing the respective FRET probes above were prepared by the methods below.

(TdCV-s)

For preparation of an expression vector for producing TdCV-s, a DNA fragment encoding ECFP, a DNA fragment encoding Venus, and a DNA fragment encoding SERCA2a were each amplified by PCR. The DNA fragment encoding ECFP was amplified with use of pECFP1 (available from Invitrogen) as a template. The DNA fragment encoding Venus was amplified with use of pRSETb-Venus (see Nagai et al., Nature Biotechnology, 2002; 20:87-90) as a template. The DNA fragment encoding SERCA2a was amplified with use of pTN3-GFP-SERCA2a (Uchida et al., J. Biol. Chem., 2003; 278(19): 16551-60) as a template.

The above amplified fragments were linked with one another in the above order from the 5′ terminal. By this, a DNA fragment including a gene (SEQ ID NO: 6) encoding TdCV-s was prepared. This DNA fragment was cloned into pcDNA3.1/Zeo(+) (available from Invitrogen).

For use of a Bac-to-Bac baculovirus expression system (available from Invitrogen), the linked DNA fragment was cloned into pFastBac 1 (available from Invitrogen), thereby obtaining an expression vector.

(V-G374, V-L577, F-L577, and V-G519)

Similarly to the TdCV-s above, DNAs for the respective constituent elements of each of V-G374, V-L577, F-L577, and V-G519 were each amplified by PCR. The amplified DNAs were then linked with one another. In this way, respective DNA fragments including genes (SEQ ID NOs: 7 through 10) encoding V-G374, V-L577, F-L577, and V-G519 were prepared. The DNA fragments were each cloned into pFastBac 1 to prepare an expression vector.

The description below deals in detail with V-G374 as an example. For preparation of an expression vector for producing V-G374, a DNA encoding ECFP, a DNA encoding an amino acid sequence corresponding to positions 1 through 374 of SERCA2a, a DNA encoding Venus, and a DNA encoding an amino acid sequence corresponding to position 375 through the C-terminus of the SERCA2a were each amplified by PCR. These amplified fragments were linked with one another in the above order from the 5′ terminal, and were then cloned into pcDNA3.1/Zeo(+). The design applied hereto was such that a linker (Gly-Ser-Leu) was inserted between the ECFP and the N-terminus of the SERCA2a. The linked DNA fragment was cloned into pFastBac 1 to prepare an expression vector.

A method similar to that for V-G374 was used for each of V-G519, V-L577, and F-L577 to prepare an expression vector. For preparation of an expression vector for F-L577, a DNA fragment (SEQ ID NO: 14) encoding TC-tag (SEQ ID NO: 13) was prepared by annealing two oligodeoxynucleotides, namely BamHI-CCPGCC-FW (SEQ ID NO: 15) and EcoRI-CCPGCC-BW (SEQ ID NO: 16).

### 2. Change Caused in FRET Efficiency by Inhibitor Addition

The above expression vectors were each transfected into COS7 cell (available from RIKEN Cell Bank, Tsukuba, Japan) to prepare a transformant. With use of the transformants, a change was examined that was caused in FRET efficiency of each FRET probe in the case where activity of SERCA was inhibited with use of thapsigargin (Tg), which was a SERCA-specific inhibitor.

The transformant prepared by transformation of F-L577 was treated with FlAsH-EDT₂ reagent (available from Invitrogen) at room temperature for 60 to 90 minutes for addition of FlAsH. The transformants prepared by transformation of the respective expression vectors were each treated to have a permeable cell membrane and refluxed in an internal solution (including 19 mM of NaCl, 125 mM of KCl, and 10 mM of Hepes-KOH, with a pH of 7.4) that included Tg and that simulated an intracellular fluid. Then, the intensity of fluorescence from each transformant was measured under IX71 inverter fluorescence microscope (available from Olympus) to calculate the amount (dR/Rbase) of a change in the ratio between the intensity of fluorescence from the fluorescence donor and that of fluorescence from the fluorescence acceptor.

(a) through (e) of FIG. 2 show the results of the above calculation. (a) through (e) of FIG. 2 are each a graph illustrating a change caused in FRET efficiency by addition of Tg to a transformant that expresses a FRET probe.

dR/Rbase was, by the addition of Tg, decreased 12% in the transformant expressing V-G374 (see (b) of FIG. 2), decreased 8% in the transformant expressing V-L577 (see (d) of FIG. 2), and increased 20% in the transformant expressing F-L577 (see (e) of FIG. 2). On the other hand, the addition of Tg caused no change in dR/Rbase in the respective transformants expressing TdCV-s and V-G519 (see (a) and (c) of FIG. 2).

The above results show that the respective FRET efficiencies of V-G374, V-L577, and F-L577 each vary according to the presence/absence of Tg. The above results, in other words, suggest that the respective FRET efficiencies of V-G374, V-L577, and F-L577 are each changed by a change occurring in structure of SERCA along with a change caused in activity of the SERCA at least by the addition of Tg.

### 3. Change Caused in FRET Efficiency by Change in Intracellular Calcium Concentration

A change in FRET efficiency of each FRET probe was examined which change was caused when a change occurred in activity of SERCA due to a change in intracellular calcium concentration.

The transformant of each FRET probe was subjected to an agonist treatment (ATP) to increase its intracellular calcium concentration. The intensity of fluorescence from each transformant was then measured under IX71 inverter fluorescence microscope (available from Olympus) to calculate dR/Rbase. Further, Indo-5F (available from Dojindo) was used to observe a change in intracellular Ca²⁺ concentration achieved at that stage, and dF/Fbase of the Indo-5F was calculated.

(a) through (d) of FIG. 3 show the results of the above calculation. (a) through (d) of FIG. 3 are each a graph illustrating a change caused in FRET efficiency by a change in calcium concentration of a cell that expresses a FRET probe. (a) through (d) of FIG. 3 each show the symbol “a” to indicate dR/Rbase of a FRET probe and the symbol “b” to indicate dF/Fbase of Indo-5F.

(a) of FIG. 3 shows the results for TdCV-s. (b) of FIG. 3 shows the results for V-L577. (c) of FIG. 3 shows the results for F-L577. (d) of FIG. 3 shows the results for V-G519. An agonist treatment was performed for 2 to 8 minutes for each of them.

dR/Rbase was, along with an increase in intracellular calcium ion concentration, increased 5% in the transformant expressing TdCV-s (see (a) of FIG. 3) and decreased by 4% in the respective transformants expressing V-L577 and F-L577 (see (b) and (c) of FIG. 3). On the other hand, no change was observed in the transformant expressing V-G519 (see (d) of FIG. 3).

The above results show that the respective FRET efficiencies of TdCV-s, V-L577, and F-L577 are each changed by an increase in intracellular calcium concentration. The above results, in other words, suggest that the respective FRET efficiencies of TdCV-s, V-L577, and F-L577 are each changed by a change occurring in structure of SERCA along with a change caused in activity of the SERCA at least by a change in intracellular calcium ion concentration.

The above experimental results show that TdCV-s, V-G374, V-L577, and F-L577 are each applicable in providing a FRET probe for detecting a change in structure of SERCA. The above experimental results also show that the above FRET probes, each of which changes its FRET efficiency as a result of a change in intracellular calcium ion concentration, are each applicable in providing a FRET probe for detecting a change in intracellular calcium ion concentration.

### 4. Change Caused in FRET Efficiency when FRET Probe has been Fixed to Structure Occurring Along with Change in Activity of SERCA

TdCV-s, V-L577, and F-L577 were each examined for what change in structure of SERCA it was capable of detecting. This examination involved FRET probes each fixed to one of the following four main structures of SERCA: E1-2Ca²⁺, E1-ATP, E2P, and E2.

Respective transformants expressing TdCV-s, V-L577, and F-L577 were each treated to have a permeable cell membrane and refluxed in an internal solution (including 19 mM of NaCl, 125 mM of KCl, and 10 mM of Hepes-KOH, with a pH of 7.4) that simulated an intracellular fluid. For a FRET probe fixed to E1-2Ca²⁺, an internal solution including 100 μM of CaCl₂ was used. For a FRET probe fixed to E1-ATP, an internal solution including 1 mM of ADP, 0.33 mM of AlCl₃, 5 mM of NaF, 1 mM of MgCl₂, and 100 μM of CaCl₂ was used. For a FRET probe fixed to E2P, an internal solution including 2 mM of BeCl₂, 8 mM of NaF, 1 mM of MgCl₂, and 5 mM of EGTA was used. For a FRET probe fixed to E2, an internal solution including 30 μM of Tg and 5 mM of EGTA was used. The intensity of fluorescence from each transformant was then measured under IX71 inverter fluorescence microscope (available from Olympus) to calculate dR/Rbase.

(a) through (c) of FIG. 4 show the results of the above calculation. (a) through (c) of FIG. 4 are each a graph illustrating a FRET efficiency of a FRET probe which FRET efficiency is achieved when the FRET probe has been fixed to a structure.

dR/Rbase measured in the transformants was as follows in the order of E1-2Ca²⁺, E1-ATP, E2P, and E2 to which the FRET probe was fixed: −1, −8, 6, and −2% for TdCV-s (see (a) of FIG. 4); −6, 12, 15; and 21% for V-L577 (see (b) of FIG. 4), and 7, 12, 6, and −2% for F-L577 (see (c) of FIG. 4). The FRET probes each varied in FRET efficiency according to the structure as above. This suggests that the FRET probes (i) reflect structural changes different from one another and (ii) each greatly vary in FRET efficiency.

In other words, (a) through (c) of FIG. 4 show that (i) TdCV-s can greatly change its FRET efficiency when SERCA changes its structure from E1-2Ca²⁺ to E1-ATP, that (ii) V-L577 can greatly change its FRET efficiency when SERCA changes its structure from E2 to E1-2Ca²⁺, and that (iii) F-L577 can greatly change its FRET efficiency when SERCA changes its structure from E2P to E2. This indicates that the above FRET probes are (i) useful in detecting structural changes different from one another and are thus (ii) applicable in providing FRET probes each for detecting a structural change that can cause a great change in FRET efficiency of the FRET probe.

The present invention is, as described above, applicable in providing FRET probes for detecting structural changes different from one another, and is thus useful in screening of compounds targeted at various structures. The present invention is further useful in detailed research on a change in structure of SERCA.

### 5. Relation Between Change in FRET Efficiency of F-L577 and Activity of Uptaking Ca²⁺

F-L577 was examined for its relation between (i) a change in FRET efficiency and (ii) activity of uptaking Ca²⁺.

First, the relation between (i) a change in FRET efficiency of F-L577 and (ii) accumulation of Ca²⁺ in an ER was examined. MgATP was added to a F-L577-expressing transformant to start accumulation of Ca²⁺ in an ER. Then, (i) a change in the FRET efficiency and (ii) a change in the intensity of fluorescence from Mag-Indo-1 in the ER were detected.

(a) and (b) of FIG. 5 show the results of the above detection. (a) and (b) of FIG. 5 are each a graph illustrating a relation between (i) a change in FRET efficiency of F-L577 and (ii) accumulation of Ca²⁺ in an ER. The addition of MgATP caused (i) Ca²⁺ to accumulate in an ER (see (b) of FIG. 5) and (ii) ΔR/Rbase of F-L577 to increase 3 to 6% (see (a) of FIG. 5).

Next, whether a change in FRET efficiency of F-L577 coincided with uptaking of Ca²⁺ was examined. (a) and (b) of FIG. 6 are each a graph showing both (i) a first derivative of the FRET efficiency of F-L577 and (ii) a first derivative of the accumulation of Ca²⁺ in an ER, the FRET efficiency and the accumulation being both indicated in (a) and (b) of FIG. 5. In other words, (a) and (b) of FIG. 6 are each a graph showing both (i) a first derivative (d(ΔR/Rbase)/dt; indicated by a solid line) of ΔR/Rbase and (ii) a first derivative (d(ΔF/Fbase)/dt; indicated by a broken line) of ΔF/Fbase. (b) of FIG. 6 is a graph illustrating an enlargement of (a) of FIG. 6. The two graphs show that the first derivative of ΔR/Rbase and that of ΔF/Fbase have respective peaks that coincide with each other. The graphs thus show that the change in structure of F-L577 occurred simultaneously with the uptaking of Ca²⁺ in an ER.

The activity of SERCA2 of uptaking Ca²⁺ is known to be dependent on the ATP concentration. In view of this, the above experiment was conducted with ATP concentrations of 0.01 mM, 0.1 mM, and 1 mM to determine whether a change in FRET efficiency of F-L577 is ATP-dependent. (a) of FIG. 7 is a graph illustrating a relation between an ATP concentration and a change in FRET efficiency of F-L577, and (b) of FIG. 7 is a graph illustrating a relation between an ATP concentration and accumulation of Ca²⁺ in an ER. The two graphs show that a change in FRET efficiency of F-L577 is dependent on the ATP concentration (see (a) of FIG. 7) and that this dependency is similar to the dependency of Ca²⁺ accumulation on the ATP concentration.

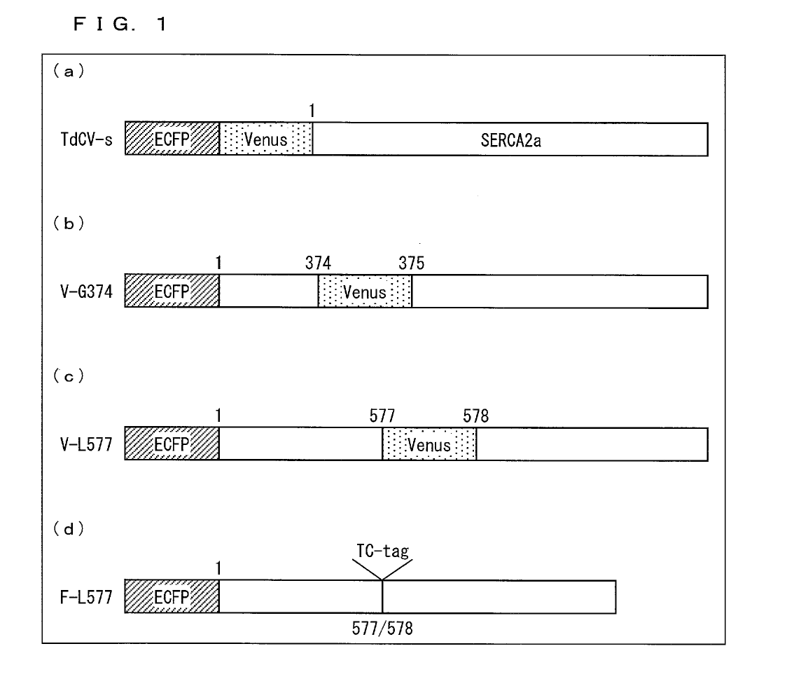

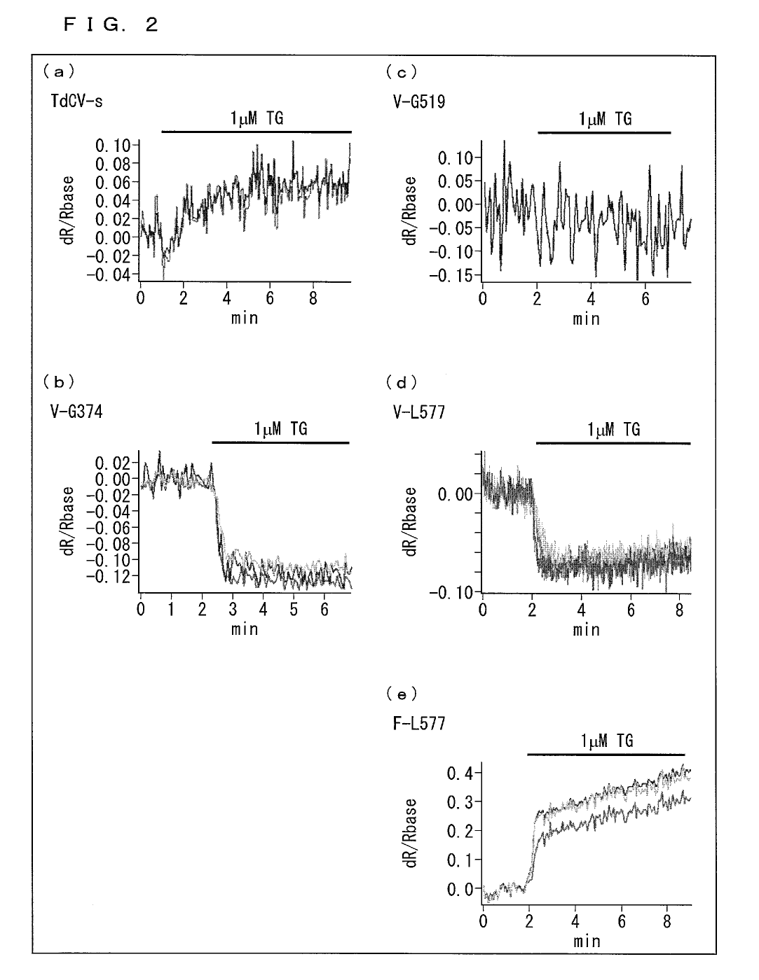

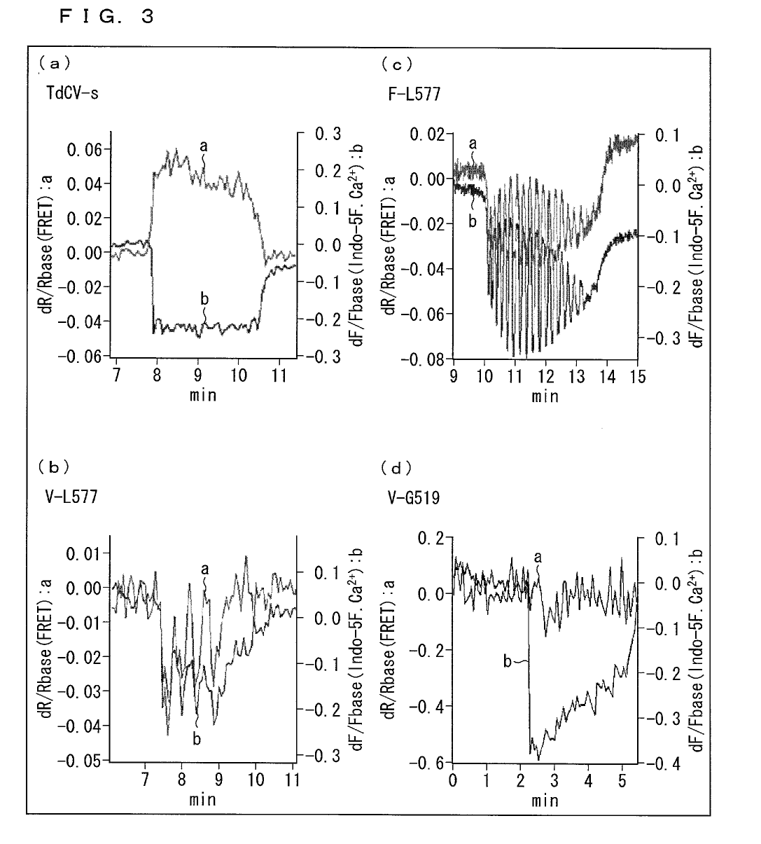

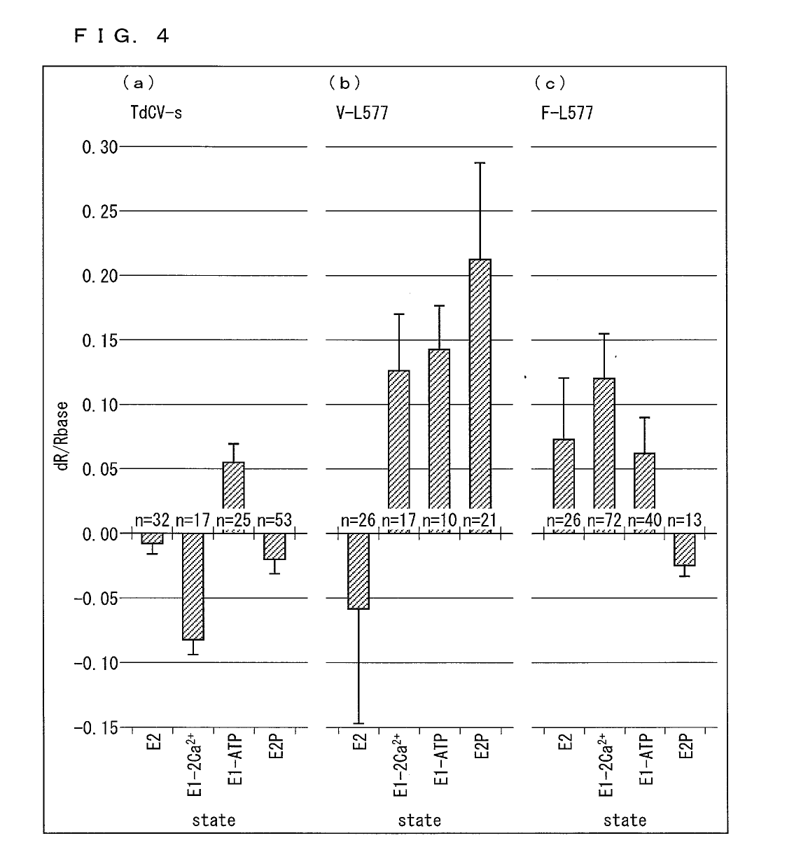

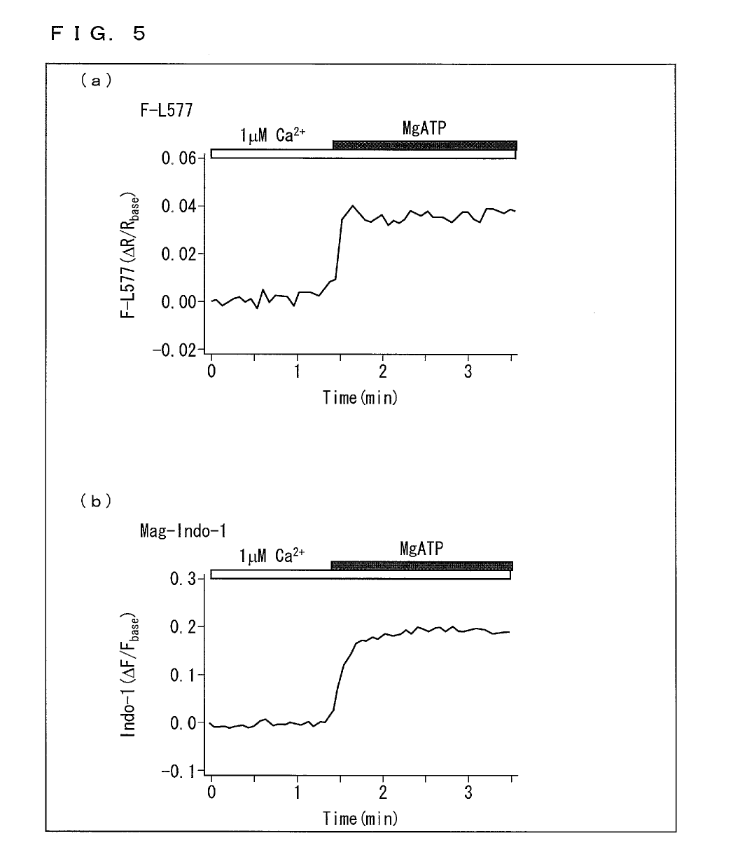

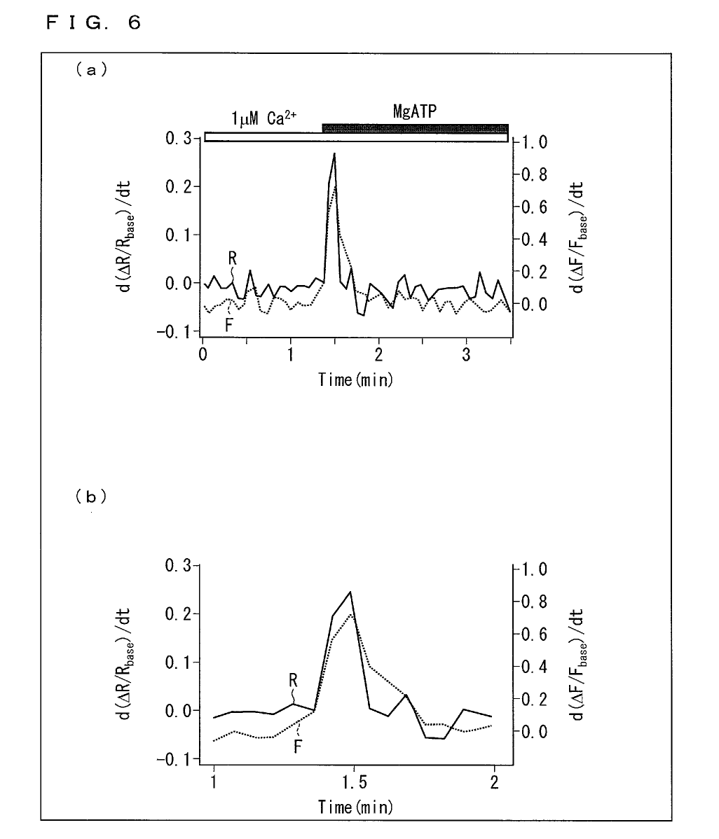

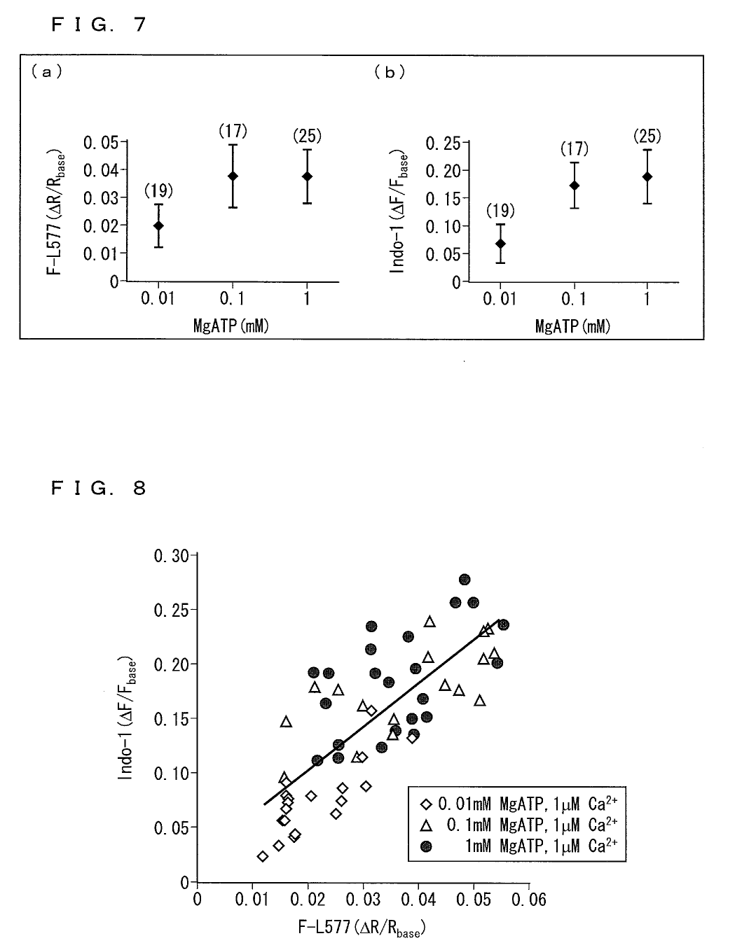

FIG. 8 is a graph illustrating a correlation between (i) the FRET efficiency of F-L577 and (ii) accumulation of Ca²⁺ in an ER (that is, the amount of a change of fluorescence from Mag-Indo-1 in an ER). FIG. 8 illustrates a correlation (r=0.767 and N=61) at different ATP concentrations. The results shown in this graph indicate that there is a high correlation between the response of F-L577 and that of Mag-Indo-1.

The above results show that a positive change in FRET efficiency of F-L577 is directly related to an instantaneous activity of SERCA2a of uptaking Ca²⁺. The above results thus show that F-L577 is a FRET probe useful in visualizing the Ca²⁺ uptaking activity of sarco/endoplasmic reticulum calcium ATPase, and is thus applicable in screening of a compound targeted at Ca²⁺ uptaking activity.

### INDUSTRIAL APPLICABILITY

The present invention allows kinetics of SERCA maintaining its activity to be observed, and is thus applicable as a sarco/endoplasmic reticulum calcium ATPase kinetics indicator. The present invention is, therefore, extremely useful in, for example, (i) research on kinetics of SERCA, (ii) screening of a molecular target drug for treating, alleviating, or preventing SERCA-related diseases, and (iii) diagnosis of such diseases.

1. A fusion protein comprising:
sarco/endoplasmic reticulum calcium ATPase;
a fluorescence donor for FRET; and
a fluorescence acceptor for FRET,
one of the fluorescence donor and the fluorescence acceptor being linked to an N-terminus side of the sarco/endoplasmic reticulum calcium ATPase,
the other of the fluorescence donor and the fluorescence acceptor being inserted between the one of the fluorescence donor and the fluorescence acceptor and the sarco/endoplasmic reticulum calcium ATPase or being inserted in an amino acid sequence of the sarco/endoplasmic reticulum calcium ATPase, the amino acid sequence corresponding to (i) amino acids 1 through 6 in SERCA2a, (ii) amino acids 369 through 380 in the SERCA2a, or (iii) amino acids 572 through 583 in the SERCA2a,
the fluorescence donor and the fluorescence acceptor being respectively (i) a fluorescent protein as a donor and (ii) a fluorescent protein as an acceptor.

2. (canceled)

3. The fusion protein according to claim 1,
wherein:
the fluorescence donor is a blue fluorescent protein; and
the fluorescence acceptor is a yellow fluorescent protein.

4. The fusion protein according to claim 1,
wherein:
the other of the fluorescence donor and the fluorescence acceptor is inserted at a position of the sarco/endoplasmic reticulum calcium ATPase, the position corresponding to a position that is between the amino acids 374 and 375 in the SERCA2a or between the amino acids 577 and 578 in the SERCA2a.

5. A fusion protein according to claim 1, comprising:
the amino acid sequence represented by one of SEQ ID NOs: 1 through 3; or
an amino acid sequence in which one or several amino acids have been deleted, replaced, or added in the amino acid sequence represented by one of SEQ ID NOs: 1 through 3.

6. A polynucleotide encoding a fusion protein according to claim 1.

7. A polynucleotide according to claim 6, comprising:
the nucleotide sequence represented by one of SEQ ID NOs: 6 through 8;
a nucleotide sequence in which one or more nucleotides have been deleted, replaced, or added in the nucleotide sequence represented by one of SEQ ID NOs: 6 through 8;
a nucleotide sequence that hybridizes, under a stringent condition, with a polynucleotide including a nucleotide sequence complementary to the nucleotide sequence represented by one of SEQ ID NOs: 6 through 8; or
a nucleotide sequence that is at least 66% identical to the nucleotide sequence represented by one of SEQ ID NOs: 6 through 8.

8. A vector comprising:
a polynucleotide according to claim 6.

9. A transformant comprising:
a polynucleotide according to claim 6.

10. A transformant comprising:
a vector according to claim 8.

11. A method for observing behavior of sarco/endoplasmic reticulum calcium ATPase,
the method comprising the step of:
detecting, with use of a fusion protein according to claim 1, an intensity of fluorescence from the fluorescence donor and an intensity of fluorescence from the fluorescence acceptor.

12. A method for screening of a compound for which sarco/endoplasmic reticulum calcium ATPase is a target molecule,
the method comprising the step of:
comparing (i) a ratio between an intensity of fluorescence from the fluorescence donor and an intensity of fluorescence from the fluorescence acceptor for a case in which a test compound has been treated with use of a fusion protein according to claim 1 and (ii) the ratio for a case in which the test compound has not been treated with use of the fusion protein according to claim 1.

13. A kit for observing behavior of sarco/endoplasmic reticulum calcium ATPase,
the kit comprising:
a polynucleotide according to claim 6.

14. (canceled)

15. A fusion protein comprising:
sarco/endoplasmic reticulum calcium ATPase;
a fluorescence donor for FRET; and
a fluorescence acceptor for FRET,
one of the fluorescence donor and the fluorescence acceptor being linked to an N-terminus side of the sarco/endoplasmic reticulum calcium ATPase,
the other of the fluorescence donor and the fluorescence acceptor being inserted at a position of the sarco/endoplasmic reticulum calcium ATPase, corresponding to a position that is between amino acids 577 and 578 in SERCA2a,
the fluorescence donor and the fluorescence acceptor each including either (i) a fluorescent protein as a donor or an acceptor or (ii) a fluorescent substance as a donor or an acceptor, the fluorescent substance being bound specifically to a particular peptide sequence.
